(19) United States
(12) Patent Application Publication
(10) Pub. No.: US 2010/0160491 A1
(43) Pub. Date: Jun. 24, 2010

(54) COMPOSITE PARTICLES AND METHODS FOR THEIR PREPARATION

(76) Inventors: Steven P. Armes, Sheffield (GB); Andreas Schmid, South Yorkshire (GB)

Correspondence Address: CLARK & ELBING LLP, 101 FEDERAL STREET, BOSTON, MA, 02110, US

(21) Appl. No.: 12/600,788

(22) PCT Filed: May 16, 2008
(86) PCT No.: PCT/GB2008/001691

§ 371 Date: Feb. 25, 2010

(30) Foreign Application Priority Data
May 18, 2007 (GB) 0709577.1

(51) Int. Cl. C08K 7/00

(52) U.S. Cl. 523/202; 523/205; 523/209

(57) ABSTRACT

In a process for producing composite particles comprising a polymer and a finely divided inorganic solid, the process comprises providing an aqueous dispersion of a sol of the modified finely divided solid, adding at least one monomer suitable for free radical type polymerisation and adding a suitable free radical polymerisation initiator to initiate polymerisation of the monomer, wherein the reaction mixture is free from added surfactant, dispersant or auxiliary co-monomer. Compositions comprising the resulting particles are also disclosed.

The present invention relates to composite particles comprising a polymer and a finely divided inorganic solid. The invention relates in particular to nanocomposite particles. More especially, the present invention relates to composite particles in an aqueous dispersion. In particular the invention relates to such composite particles comprising an addition polymer and a silica sol. The invention further relates to film-forming compositions for such particles, to films or filmic substrates formed from the compositions and to methods of making the particles and the films. The composite particles of the invention are preferably formed in the absence of any added surfactant or dispersant or any auxiliary co-monomer.

Aqueous dispersions of composite particles are generally well known. Conventionally such dispersions are fluid systems whose disperse phase in the aqueous dispersion medium comprises polymer coils consisting of one or more intertwined polymer chains—known as the polymer matrix—and particles composed of finely divided inorganic solid. The diameter of the composite particles is frequently within the range from 30 to 5000 nm.

Like polymer solutions when the solvent is evaporated, and like aqueous polymer dispersions when the aqueous dispersion medium is evaporated, aqueous dispersions of composite particles have the potential to form modified polymer films containing finely divided inorganic solid, and on account of this potential they are of particular interest as modified binders—for example, for paints (especially for making such paints tough, transparent and/or scratch-resistant) or for compositions for coating leather, paper or plastic films or fibres or for fire retardant coatings. The composite particle powders obtainable in principle from aqueous dispersions of composite particles are, furthermore, of interest as additives for plastics, as components for toner formulations, or as additives in electrophotographic applications.

The following prior art illustrates techniques for the preparation of aqueous dispersions of composite particles.

A process for preparing polymer-enveloped inorganic particles by means of aqueous emulsion polymerization is disclosed in U.S. Pat. No. 3,544,500. In this process the inorganic particles are coated with water-insoluble polymers before the actual aqueous emulsion polymerization. The inorganic particles thus treated in a complex process are dispersed in an aqueous medium using special stabilizers.

EP 0 104 498 relates to a process for preparing polymer-enveloped solids. A characteristic of the process is that finely divided solids having a minimal surface charge are dispersed in the aqueous polymerization medium by means of a non-ionic protective colloid and the ethylenically unsaturated monomers added are polymerized by means of non-ionic polymerization initiators.

U.S. Pat. No. 4,421,660 discloses a process for preparing aqueous dispersions whose disperse particles feature inorganic particles surrounded completely by a polymer shell. The aqueous dispersions are prepared by free-radically initiated aqueous emulsion polymerization of hydrophobic, ethylenically unsaturated monomers in the presence of inorganic particles in disperse distribution.

A process for polymerizing ethylenically unsaturated monomers in the presence of uncharged inorganic solid particles stabilized in the aqueous reaction medium using non-ionic dispersants is disclosed in U.S. Pat. No. 4,608,401.

Free-radically initiated aqueous emulsion polymerization of styrene in the presence of modified silicon dioxide particles is described by Furusawa et al. in the Journal of Colloid and Interface Science 109 (1986) 69 to 76. These special silicon dioxide particles, having an average diameter of 190 nm, are modified using hydroxypropylcellulose.

Hergeth et al. (Polymer 30 (1989) 254 to 258) describe the free-radically initiated aqueous emulsion polymerization of methyl methacrylate and, respectively, vinyl acetate in the presence of aggregated, finely divided quartz powder. The particle sizes of the aggregated quartz powder used are between 1 and 35 μm.

GB 2 227 739 relates to a special emulsion polymerization process in which ethylenically unsaturated monomers are polymerized using ultrasound waves in the presence of dispersed inorganic powders which have cationic charges. The cationic charges of the dispersed solid particles are generated by treating the particles with cationic agents, preference being given to aluminium salts. The document, however, gives no details of particle sizes and stability of the aqueous dispersions of solids.

EP 0 505 230 discloses the preparation of polymer-encapsulated silica particles by the free-radical aqueous emulsion polymerization of ethylenically unsaturated monomers in the presence of surface-modified silicon dioxide particles. The silica particles are functionalized using special acrylic esters containing silanol groups.

U.S. Pat. No. 4,981,882 relates to the preparation of polymer-encapsulated composite particles by means of a special emulsion polymerization process. Essential features of the process are finely divided inorganic particles dispersed in the aqueous medium by means of basic dispersants; the treatment of these inorganic particles with ethylenically unsaturated carboxylic acids; and the addition of at least one amphiphilic component for the purpose of stabilizing the dispersion of solids during the emulsion polymerization. The finely divided inorganic particles preferably have a size of between 100 and 700 nm.

Haga et al. (cf. Angewandte Makromolekulare Chemie, 189 (1991) 23 to 34) describe the influence of the nature and concentration of the monomers, the nature and concentration of the polymerization initiator, and the pH on the formation of polymers on particles of titanium dioxide dispersed in an aqueous medium. High encapsulation efficiencies are obtained for the titanium dioxide particles if the polymer chains and the titanium dioxide particles have opposite charges. However, the publication contains no information on the particle size and the stability of the titanium dioxide dispersions.

In Tianjin Daxue Xuebao 4 (1991) 10 to 15, Long et al. describe the dispersant-free polymerization of methyl methacrylate in the presence of finely divided particles of silicon dioxide and, respectively, of aluminium oxide. High encapsulation yields of the inorganic particles are obtained if the end groups of the polymer chains and the inorganic particles have opposite charges.

EP 0 572 128 relates to a preparation process for composite polymer encapsulated particles in which the inorganic particles are treated with an organic polyacid or a salt thereof at a defined pH in an aqueous medium, and the subsequent free-radically initiated aqueous emulsion polymerization of ethylenically unsaturated monomers takes place at a pH<9.

Bougeat-Lami et al. (cf. Angewandte Makromolekulare Chemie 242 (1996) 105 to 122) describe the reaction products obtainable by free-radical aqueous emulsion polymerization of ethyl acrylate in the presence of functionalized and unfunctionalized silicon dioxide particles. These polymerizations were generally carried out using anionically charged silicon dioxide particles, the nonionic nonylphenol ethoxylate NP30 and the anionic sodium dodecylsulfate (SDS) as emulsifiers, and potassium peroxodisulfate as free-radical polymerization initiator. The authors describe the resulting reaction products as aggregates containing more than one silicon dioxide particle or as polymer clusters which form on the silicon dioxide surface.

Paulke et al. (cf. Synthesis Studies of Paramagnetic Polystyrene Latex Particles in Scientific and Clinical Applications of Magnetic Carriers, pages 69 to 76, Plenum Press, New York, 1997) describe three fundamental synthesis routes for preparing aqueous polymer dispersions containing iron oxide. Because of the deficient stability of the aqueous dispersion of solids, the use of freshly precipitated iron(II/III) oxide hydrate is an unavoidable precondition for all of the synthesis routes. In the first synthesis route, in the presence of this freshly precipitated iron(II/III) oxide hydrate, the free-radically initiated aqueous emulsion polymerization of styrene takes place with SDS as emulsifier and potassium peroxodisulfate as polymerization initiator. In the authors' second (and favoured) synthesis route, styrene and methacrylic acid are polymerized in the presence of the freshly precipitated iron(II/III) oxide hydrate, the emulsifier N-cetyl-N-trimethylammonium bromide (CTAB), and special surface-active polymerization initiators (PEGA 600) in methanolic/aqueous medium. The third synthesis route uses ethanol and methoxyethanol as polymerization medium, hydroxypropylcellulose as emulsifier, benzoyl peroxide as polymerization initiator, and a special iron(II/III) oxide/styrene mixture in order to prepare polymer dispersions containing iron oxide.

Armes et al. (cf. Advanced Materials 11 (5) (I 999) 408 to 410) describe the preparation of polymer-silicon dioxide composite particles which are obtainable in an emulsifier-free, free-radically initiated aqueous emulsion polymerization at a pH of 10 with special olefinically unsaturated monomers in the presence of dispersed silicon dioxide particles. Postulated as a precondition for the formation of polymer particles containing silicon dioxide is a strong acid/base interaction between the polymer formed and the acidic silicon dioxide particles used. Polymer particles containing silicon dioxide were obtained with poly(4-vinylpyridine) and copolymers of styrene and, respectively, methyl methacrylate with 4-vinylpyridine. The smallest possible content of 4-vinylpyridine auxiliary co-monomer in methyl methacrylate and/or styrene monomer mixtures required to form composite particles comprising silicon dioxide ranged from 4 to 10 mol %.

U.S. Pat. No. 6,756,437 describes a process for preparing aqueous composite-particle dispersions wherein the dispersed inorganic solid particles and the radical-generating and/or dispersing components used in the free-radically initiated aqueous emulsion polymerization have opposite charges.

U.S. Pat. No. 6,833,401 describes a process for preparing aqueous composite-particle dispersions wherein the dispersed inorganic solid particles have a nonzero electrophoretic mobility and wherein specific copolymers are used for the aqueous emulsion polymerization.

Armes et al (Langmuir 2006, 22 4923-4927) describe the preparation of composite nanoparticles by alcoholic dispersion polymerisation of styrene using commercial alcoholic silica sols. Formation of colloidally stable nanocomposite particles requires the use of a cationic azo initiator.

The following abbreviations are used herein:

PSt polystyrene
St styrene
n-BuA n-butyl acrylate
P(n-BuA) poly(n-butyl acrylate)
MMA methyl methacrylate
P(MMA) poly(methyl methacrylate)
P(St-co-n-BuA) or P(St-n-BuA) poly(styrene-n-buyl acrylate) copolymer
P(MMA-co-n-BuA) poly(methyl methacrylate-n-butyl acrylate) coploymer
AIBA 2,2′-Azobis(isobutyramidine) dihydrochloride
APS ammonium persulfate
TEM transmission electron microscopy
XPS X-ray photoelectron spectroscopy
DLS dynamic light scattering
TGA thermogravimetric analysis
DCP disc centrifuge photosedimentometry
ESI electron spectroscopy imaging
DSC differential scanning calorimetry

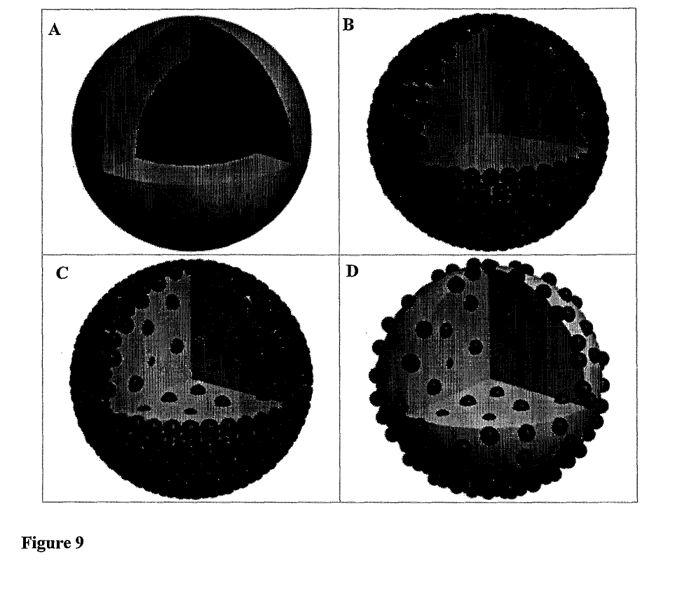

The present invention seeks to provide composite nanoparticles comprising a polymer and a finely divided solid, more especially aqueous dispersions of such nanocomposite particles and to methods of making such particles which avoid the use of the surfactants, dispersants, organic co-solvents and auxiliary co-monomers which are required by the prior art. In particular, the invention seeks to provide such composite nanoparticles having a “core-shell” morphology which comprises an at least approximately spherical core of polymer and at least one outer layer, substantially covering the surface of the core, comprising the finely divided solid (FIG. 9B) and further to alternative morphologies which the inventors consider to be possible such as “core-shell” configurations comprising a core of finely divided solid and a shell of polymer (FIG. 9A), so called “raspberry” morphologies comprising a core of polymer having a quantity of substantially dispersed finely divided solid therein and a shell of the finely divided solid (FIG. 9C) and so-called “currant bun” configurations in which the finely divided solid is dispersed throughout the polymer particle with no contiguous shell layer (FIG. 9D). The invention illustrates means for modifying a finely-divided solid so that composite particles are obtainable without the use of surfactants, dispersants, auxiliary co-monomers (e.g. 4-vinylpyridine, 2-vinylpyridine or n-vinyl imidazole), organic co-solvents and the like. The finely divided solid is preferably a surface-modified silica. In other aspects the present invention seeks to provide methods of increasing the aggregation efficiency of the finely divided solid (preferably silica) within the nanocomposite particles. In further aspects the invention seeks to provide film-forming aqueous dispersions of nanocomposite particles.

In the present disclosure, an auxiliary co-monomer is a co-monomer which (in the prior art) is included because of its specific functionality, in particular because it includes particular functional groups, whereby the resultant polymer is able to bind to the particles and finely divided solid. The present disclosure seeks to avoid such specialised monomers and uses, at least primarily, “commodity” monomers which are generally commercially available at relatively low cost.

The nanocomposite particles and dispersions thereof in accordance with the present invention find particular use as components of paints and coatings, especially exterior paints and coatings. Preparing such aqueous dispersions from which surfactant, for example, is absent leads to improved properties, more especially improved film-forming properties and properties such as increased water resistance, higher dirt and abrasion resistance, improved flame retardancy and reduced whitening. Preparing such composite particles in the absence of auxiliary co-monomers is generally much more cost-effective. Not requiring organic co-solvents is also economically advantageous, as well as allowing formulations with low or zero volatile organic compounds (VOCs) to be achieved.

According to a first aspect of the invention, there is provided a process for producing composite particles comprising a polymer and a modified finely divided inorganic solid, the process comprising providing an aqueous dispersion of a sol of the modified finely divided solid, adding at least one monomer suitable for free radical type polymerisation and adding a suitable free radical polymerisation initiator to initiate polymerisation of the monomer, wherein the reaction mixture is free from one or more of (and more especially is free from all of) added surfactant, dispersant, organic co-solvent and auxiliary co-monomer.

Thus the method of this aspect of the invention enables the preparation of nanocomposite particles in entirely aqueous media, in contrast to alcoholic or other organic media. The polymerisation is carried out in situ, that is, in the presence of the finely divided inorganic solid. Both these features represent routes which are commercially more attractive than previous methods.

The polymerisation step is most preferably an emulsion polymerisation. In a typical conventional emulsion polymerisation the monomers) are not soluble in the reaction medium (continuous phase), which is typically water. Typically, emulsified monomer droplets of 1-10 μm in diameter which are formed when the reaction mixture is stirred are stabilised by a surfactant. Despite the insolubility of the monomer(s), a small amount will normally be dissolved and solubilised in the continuous phase by the surfactant. Radicals produced by a water-soluble initiator can enter the resulting monomer-swollen surfactant micelles, where the polymerisation is thus initiated and continued. This is called “micellar nucleation”. In another mechanism commonly called “homogeneous nucleation” propagation initiated by radicals in the continuous phase leads to dissolved oligomers which precipitate from solution as soon as their limit of solubility is surpassed. In both micellar and homogeneous nucleation, the growing polymer chain is monomer-swollen, fed by diffusion from the monomer droplets, and sub-micrometre-sized surfactant-stabilised polymer particles are formed. Usually, high monomer conversions can be obtained within rather short reaction durations.

An important variation of the above-mentioned technique is surfactant-free emulsion polymerisation, which utilises an ionic initiator, resulting in oligomers containing an ionic end group. These oligomers act as an emulsifier, forming micelles and hence solubilising further monomer and initiator, finally leading to a charge-stabilised polymer latex. The polymerisation step of the present disclosure most preferably employs surfactant-free emulsion polymerisation.

Emulsion polymerisation offers a number of advantages, for example high molecular weight polymers can be efficiently prepared and the reaction solution viscosity remains low, which allows ease of stirring. Moreover, this aqueous-based technique is perfectly suited for industrial processes due to low costs and environmental-friendliness. It may also be noted that the resulting dispersions can often be directly used without further processing for purposes such as paints, coatings, adhesives and inks.

In a preferred embodiment of the first aspect of the invention, the finely divided solid is modified with a modifying moiety configured for bonding interaction with the polymer.

In preferred embodiments the modified finely divided solid is a modified silica.

Preferably the silica sol comprises at least 20 wt % SiO₂, and more especially the silica sol comprises at least 30 wt % SiO₂.

In further preferred embodiments the silica has a particle size in the range of from about 5 nm to about 50 nm, especially in the range of from about 5 nm to 30 nm and more especially in the range of from about 5 nm to about 20 nm.

In further preferred embodiments the modifying moiety is a silane so that the modified silica is a silane modified silica.

Preferably the modified silica may be represented by

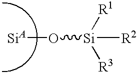

where Si^{A} is a silicon atom of a silica particle, [symbol] represents a link between O and Si and may be a bonding interaction or an intermediate linking atom or linking group, R¹ and R³ independently represent H, C₁ to C₆ alkyl or OR⁹ where R⁹ represents C₁ to C₆ alkyl and R² represents a C₂ to C₁₂ straight chain or branched alkyl group including at least one terminal oxygen containing group and the alkyl chain of R2 may optionally be interrupted by one or more moieties selected from O, S, NH, preferably O.

In preferred embodiments the modified silica may be represented by

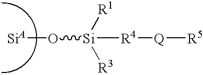

where R⁴ represents C₁ to C₆ alkyl Q represents a moiety selected from O, S, NH and R⁵ represents a straight chain or branched alkyl group including at least one terminal oxygen containing group.

Preferably Q represents O.

Preferably R⁵ is selected from

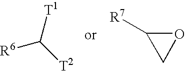

where R⁶ and R⁷ represent CH₂ or CH₂CH₂ T¹ and T² independently represent H, OH or R⁸OH where R⁸ is CH₂ or CH₂CH₂, provided that T¹ and T² are not both H. Most preferably T¹ is OH and T² is CH₂OH.

Preferably R¹ and R³ are selected from CH₃, CH₂CH₃, OCH₃ and OCH₂CH₃, and more especially from CH₃ and OCH₃.

In some preferred processes according to the first aspect of the invention the weight ratio of silane to silica is from about 0.05 to about 1.

Preferably the silica sol has a pH in the range of from about 5 to about 9, more especially 6 to 8.

In preferred embodiments according to the first aspect of the invention, the modifying moiety comprises a terminal hydroxy group.

Preferably the monomer comprises at least one ethylenically unsaturated group.

In particularly preferred embodiments of the first aspect of the invention the monomer is selected from the group comprising

ethylene,
vinyl aromatic monomers such as styrene, α-methylstyrene, o-chlorostyrene or vinyltoluenes,
esters of vinyl alcohol and C₁-C₁₈ monocarboxylic acids, such as vinyl acetate, vinyl propionate, vinyl n-butyrate (ethenyl butanoate), vinyl laurate and vinyl stearate, esters of C₃-C₆ α,β-monoethylenically unsaturated mono- and di-carboxylic-acids, such as acrylic acid, methacrylic acid, maleic acid, fumaric acid and itaconic acid, with C₁-C₁₂, alkanols, such as methyl, ethyl, n-butyl, isobutyl and 2-ethylhexyl acrylate and methacrylate, dimethyl maleate and di-n-butyl maleate,
nitrites of α,β-monoethylenically unsaturated carboxylic acids, such as acrylonitrile, C₄₋₈ conjugated dienes, such as 1,3-butadiene and isoprene
α,β-monoethylenically unsaturated mono- and dicarboxylic acids and their amides, such as acrylic acid, methacrylic acid, maleic acid, fumaric acid, itaconic acid, acrylamide and methacrylamide,
vinylsulfonic acid, 2-acrylamido-2-methylpropanesulfonic acid, styrene-sulfonic acid and the water-soluble salts thereof, and N-vinylpyrrolidone.

More especially the monomer is preferably selected from the group comprising esters of C₃-C₆ α,β-monoethylenically unsaturated mono- and di-carboxylic-acids with C₁-C₈, preferably, C₁-C₄ alkanols.

In particularly preferred embodiments the monomer is a styrene.

Preferably the monomers comprise a styrene and an ester of a C₃-C₆ α,β-monoethylenically unsaturated mono- and di-carboxylic acids, such as acrylic acid, methacrylic acid, maleic acid, fumaric acid and itaconic acid, with C₁-C₁₂, alkanols, such as methyl, ethyl, n-butyl, isobutyl and 2-ethylhexyl acrylate and methacrylate, dimethyl maleate and di-n-butyl maleate.

In some preferred embodiments, the monomers comprise a styrene and a C₁ to C₁₂ alkyl acrylate, in particular styrene and n-butyl acrylate.

In other preferred embodiments, the monomers comprise a methyl methacrylate and a C₁ to C₁₂ alkyl acrylate, in particular methyl methacrylate and n-butyl acrylate.

In particularly preferred processes according to the first aspect of the invention, the initiator is a cationic azo initiator.

According to a second aspect of the invention there is provided an aqueous composition comprising composite particles comprising a polymer and a finely divided inorganic solid when obtained or when obtainable by a process as defined in the first aspect of the invention.

According to a third aspect of the invention there is provided an aqueous composition comprising composite particles, said composite particles comprising a polymer formed by polymerisation of a styrene and an ester of a ethylenically unsaturated mono- and di-carboxylic acids, such as acrylic acid, methacrylic acid, maleic acid, fumaric acid and itaconic acid, with C₁-C₁₂, alkanols, such as methyl, ethyl, n-butyl, isobutyl and 2-ethylhexyl acrylate and methacrylate, dimethyl maleate and di-n-butyl maleate, and a modified finely divided solid.

Preferably in this third aspect of the invention the finely divided solid is modified with a modifying moiety configured for bonding interaction with the polymer.

Preferably the modified finely divided solid is a modified silica.

Preferably the silica sol comprises at least 20 wt % SiO₂ and more especially the silica sol comprises at least 30 wt % SiO₂.

In preferred compositions the silica has a particle size in the range of from about 5 nm to about 50 nm, more especially 5 nm to about 30 nm and in particular in the range of from about 5 nm to about 20 nm.

Preferably the modifying moiety is a silane so that the modified silica is a silane modified silica.

In preferred embodiments, the silane is an epoxysilane, in particular an epoxysilane with a glycidoxy group.

Preferably the weight ratio of silane to silica is from about 0.05 to about 1.

Preferably the silica sol has a pH in the range of from about 5 to about 9, more especially 6 to 8.

In some preferred embodiments the modifying moiety comprises a terminal hydroxy group.

Preferably the composition according to this aspect of the invention is film-forming.

According to a fourth aspect of the invention there is provided a paint or coating composition comprising composite particles as defined in the third aspect of the invention.

Preferably in any of the first to fourth aspects of the invention the composite particles have a zeta potential which is substantially the same as that of the initial finely divided solid.

Preferably the composite particles according to the present invention have a diameter in the range of from about 50 nm to about 1000 nm, more preferably from about 100 nm to about 600 nm and especially from about 150 nm to about 450 nm.

In preferred embodiments of the invention, a dispersion of the composite particles has a finely divided solid aggregation efficiency in the range of from about 70% to about 100% and more especially in the range of from about 90% to about 100%.

Preferably the composite particles have a silica content in the range of from about 10 wt % to about 80 wt %, and preferably 15 wt % to 50 wt % and more preferably 15 wt % to 40 wt %.

In particularly preferred embodiments of the invention at least some of said composite particles have a morphology comprising a polymer core and a shell of the finely divided solid surrounding the core.

In variations of the above embodiments the core comprises finely divided solid particles dispersed therein.

In alternative embodiments at least some of said composite particles have a morphology in which the finely divided solid is dispersed throughout the polymer particle with no contiguous shell layer.

For a better understanding of the invention, and to show how the same may be carried into effect, reference will be made, by way of example only, to the following drawings, in which:

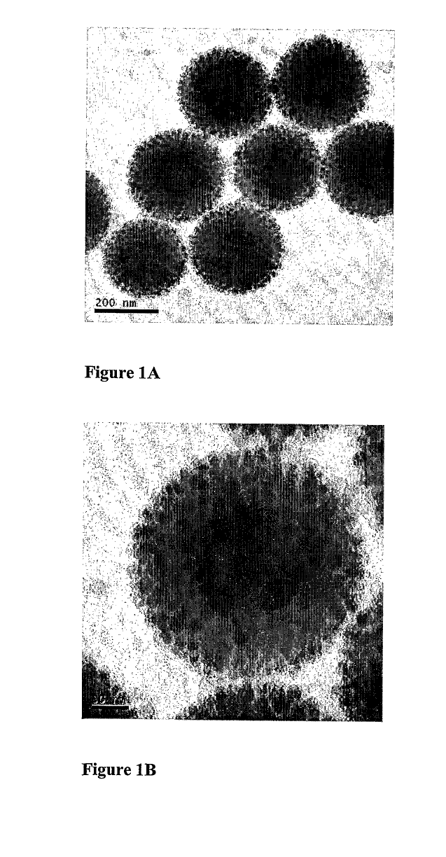

FIGS. 1A and 1B show transmission electron microscope (TEM) images of polystyrene-silica nanocomposite particles of Example 1;

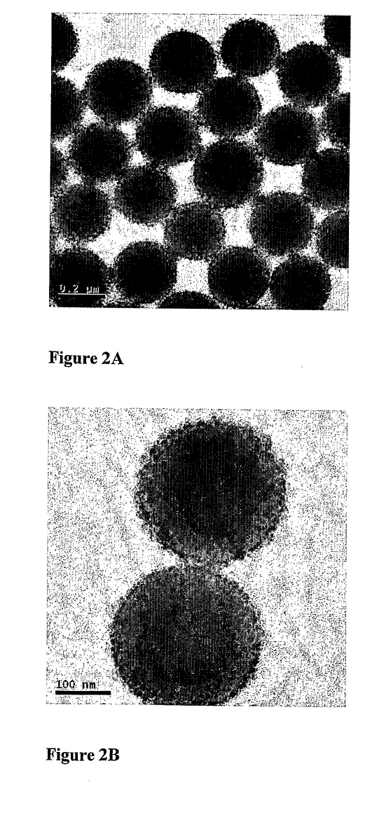

FIGS. 2A and 2B show transmission electron microscope (TEM) images of polystyrene-silica nanocomposite particles of Example 14;

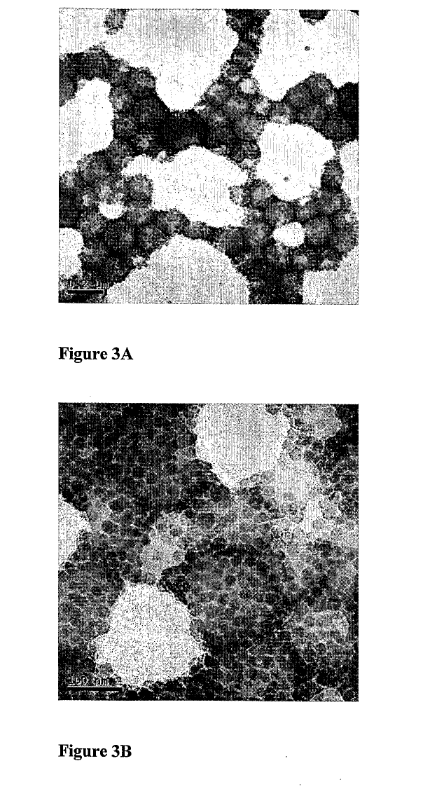

FIGS. 3A and 3B show transmission electron microscope (TEM) images of polystyrene-silica nanocomposite particles of Example 53;

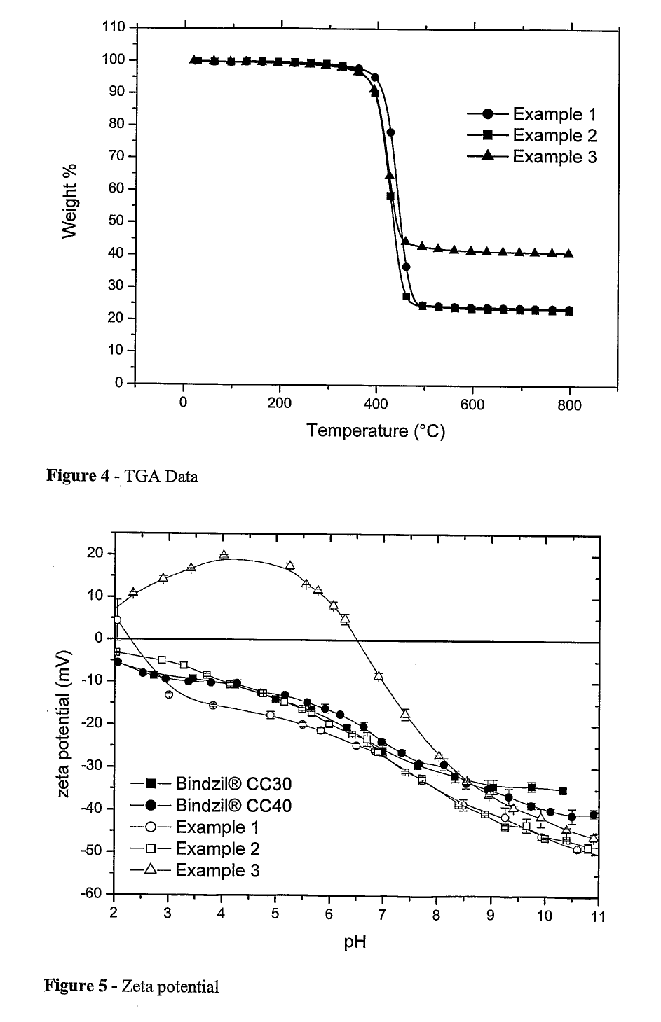

FIG. 4 shows thermogravimetric analysis data for Examples 1, 14 and 53.

FIG. 5 shows zeta potential data for the composite particles of Examples 1, 14 and 53 together and also for two modified silicas (Bindzil CC 30 and Bindzil CC40);

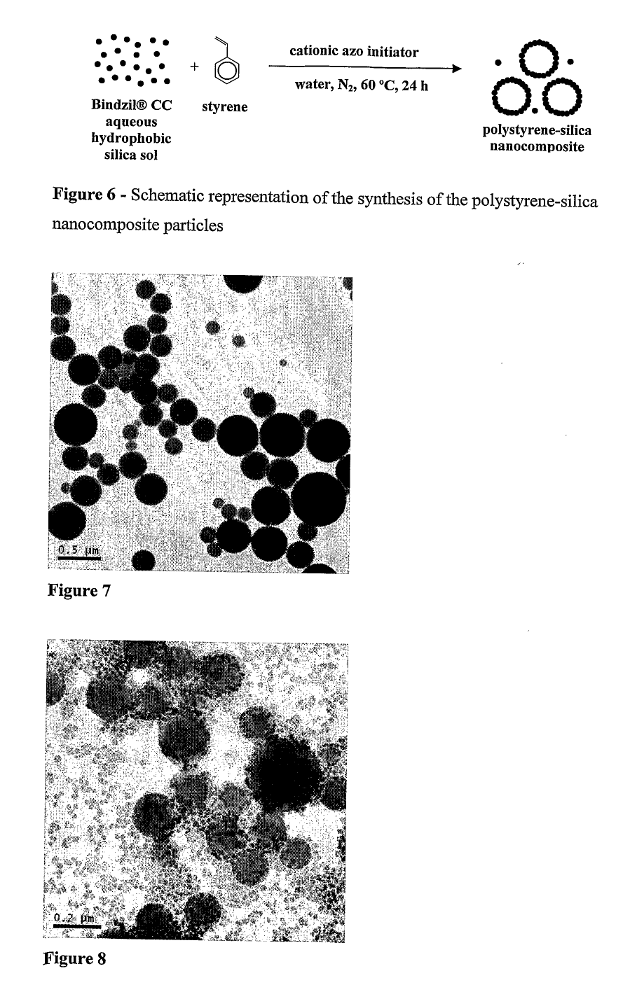

FIG. 6 shows schematically the process of forming the composite particles;

FIG. 7 shows a transmission electron microscope (TEM) image of the product of Comparative Example 2;

FIG. 8 shows a transmission electron microscope (TEM) image of the product of Comparative Example 3 and

FIG. 9 illustrates schematically different morphologies of composite particles.

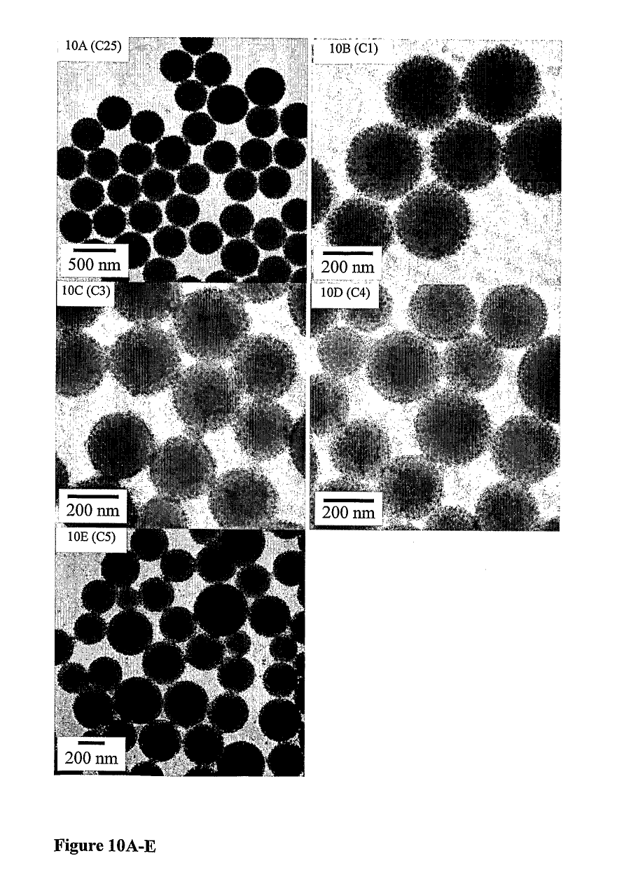

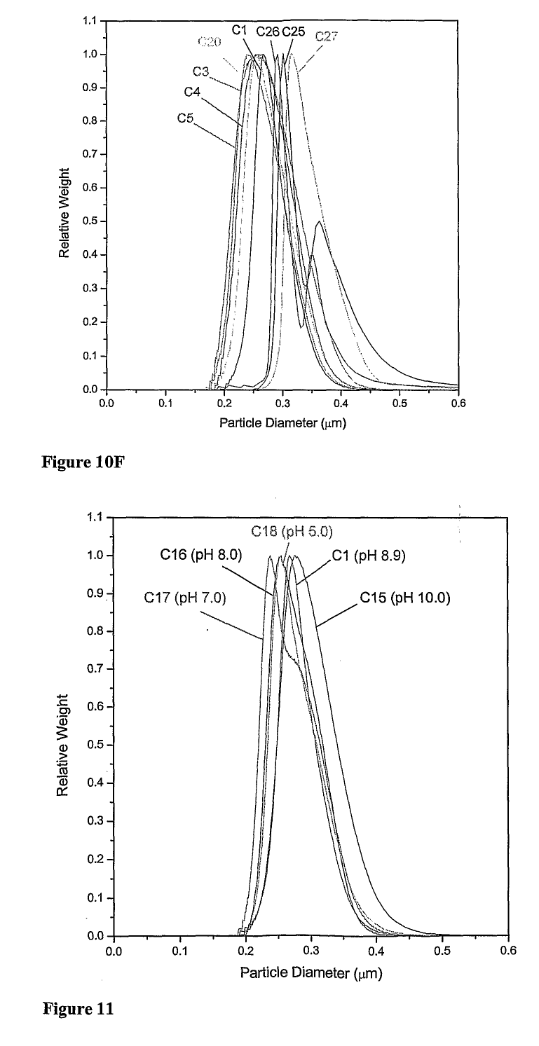

FIGS. 10A to 10E show images of representative polystyrene/silica nanocomposites formed using varying initial concentration of silica sol (Bindzil CC40) and poly(stryrene). Corresponding DCP (disc centrifuge photosedimentometry) curves are shown in FIG. 10F.

FIG. 11 shows DCP curves of polystyrene/silica nanocomposite particles prepared by emulsion polymerisation of styrene using cationic AIBA and a 19 nm commercial aqueous Bindzil CC40 silica sol at different pH.

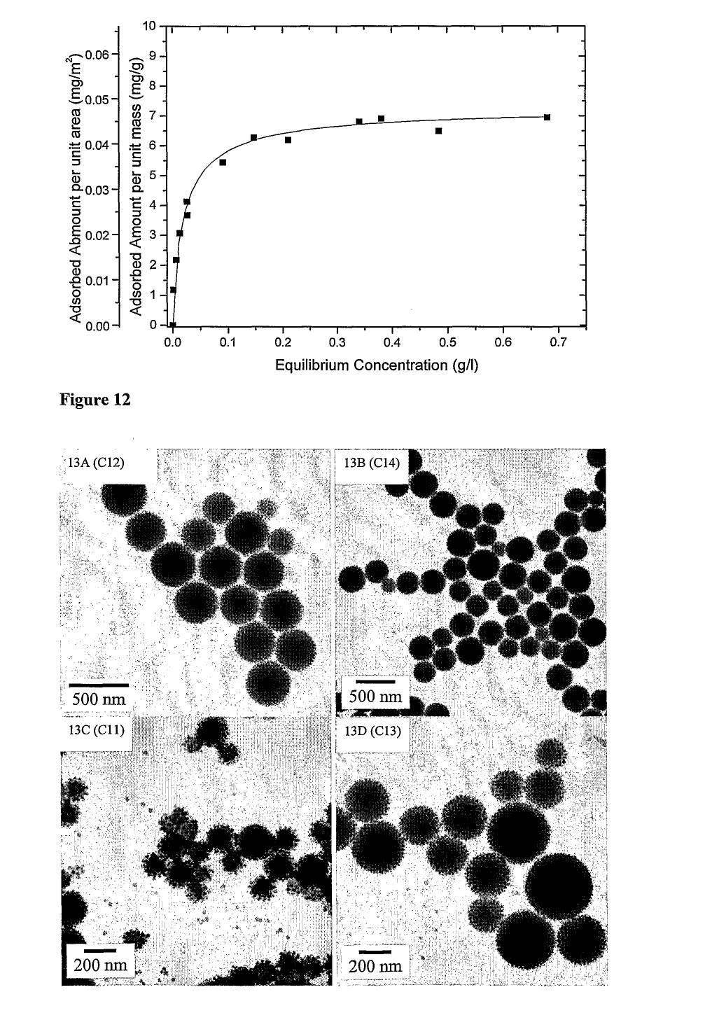

FIG. 12 shows a Langmuir-type isotherm obtained for the adsorption of the cationic AIBA initiator onto 19 nm Bindzil CC40 at pH 8.9 and 20° C.

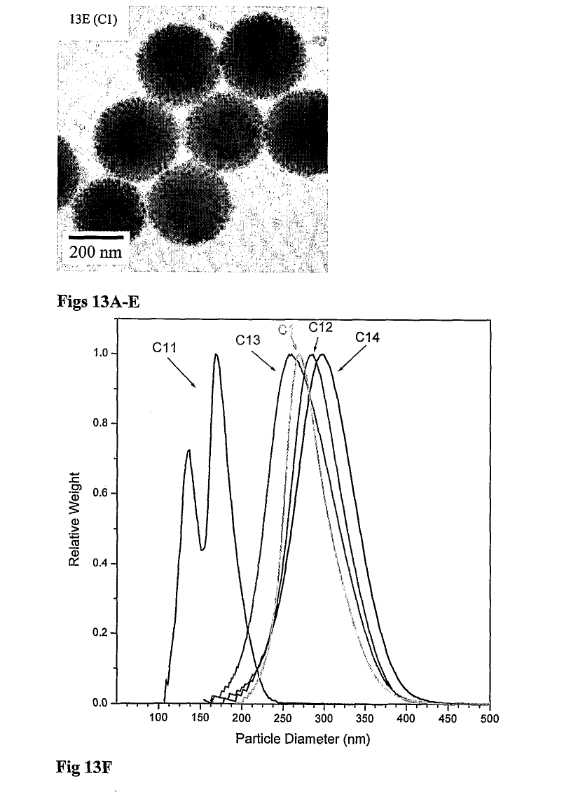

FIG. 13 shows TEM images of polystyrene/silica nanocomposite particles prepared by aqueous emulsion polymerisation using a commercial aqueous 19 nm Bindzil CC40 silica sol using various amounts of silica sol at a constant initiator to silica mass ratio (conditions, and other data, are shown in Table 6).

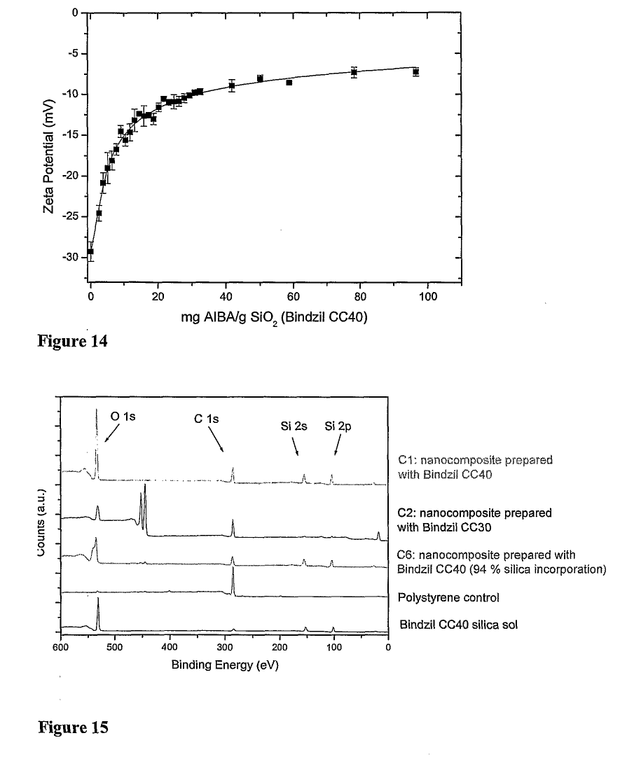

FIG. 14 shows Zeta potential vs. AIBA initiator/silica mass ratio determined by measuring the zeta potential on addition of increasing amounts of AIBA to Bindzil CC40 silica at pH 8.9 and 20° C.

FIG. 15 shows XPS survey spectra obtained for three polystyrene/silica nanocomposites prepared with the 19 nm Bindzil CC40 (C1 and C6) and 12 nm Bindzil CC30 (C2) silica sol. A polystyrene control prepared in the absence of silica (C31) and the pristine Bindzil CC40 silica sol are also shown.

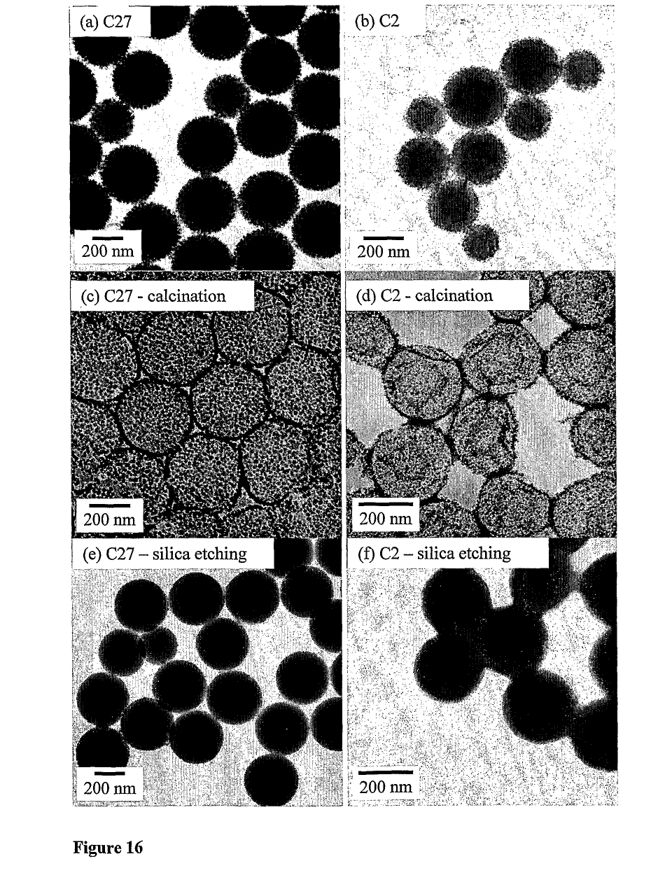

FIG. 16 shows TEM images of nanocomposite particles prepared with the 19 nm Bindzil CC40 silica sol (a,c,e) and the 12 nm Bindzil CC30 silica sol (b,d,f). Untreated particles are shown in images (a) and (b), particles after calcination at 550° C. leading to removal of the polystyrene component are shown in images (c) and (d) and particles treated with 50% sodium hydroxide leading to removal of the silica sol are shown in images (e) and (f).

FIG. 17 shows TEM images of ultramicrotomed polystyrene/silica nanocomposite particles prepared with the commercial glycerol-modified 19 nm Bindzil CC40 silica sol (sample C1 in Table 7b).

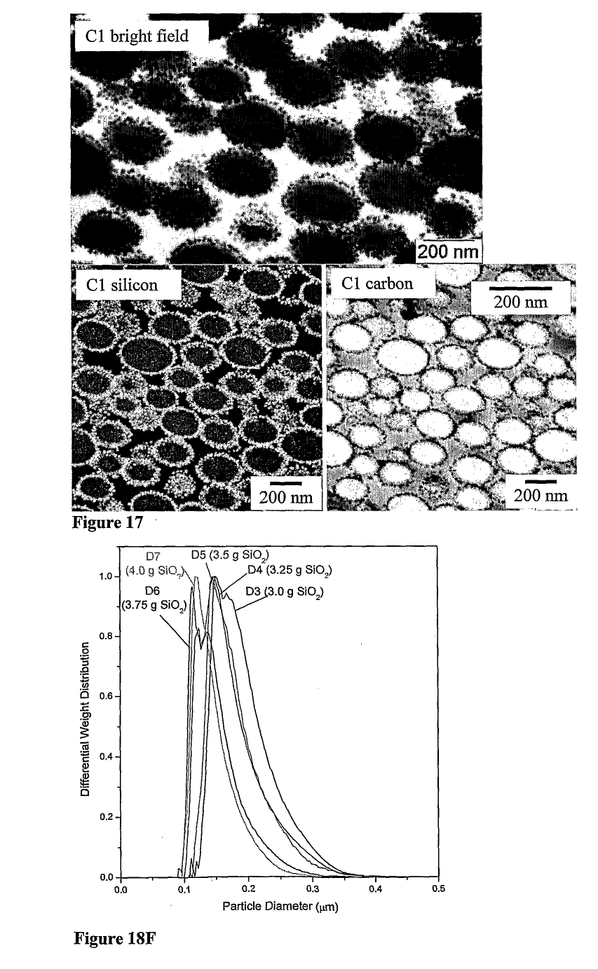

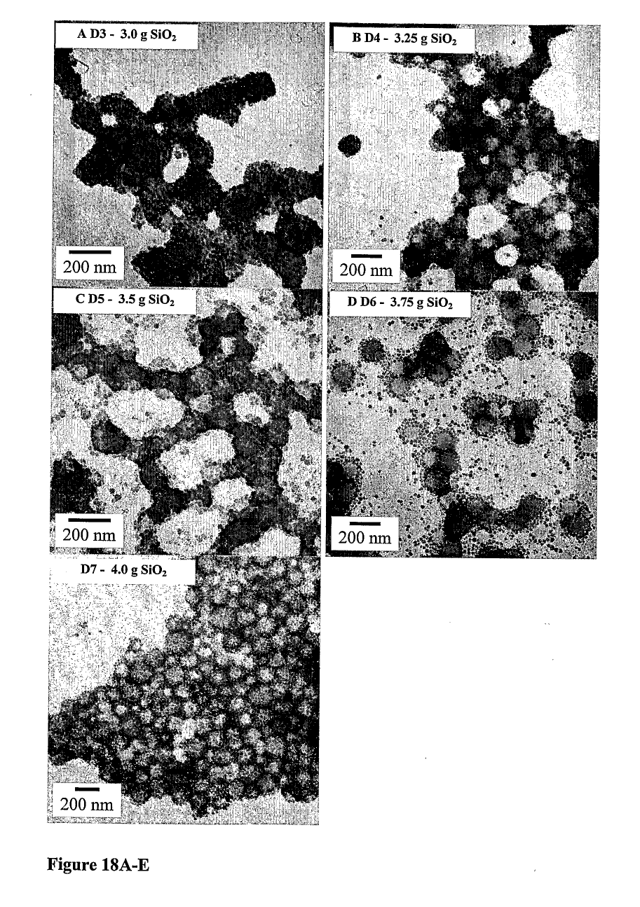

FIG. 18 shows TEM images of unpurified P(St-n-BuA)/SiO₂ nanocomposite particles prepared in the presence of various amounts of initial 19 nm Bindzil CC40 silica sol mass using the cationic AIBA initiator at 60° C. for 24 h (FIGS. 18A-E). The corresponding disc centrifuge photosedimentometry curves are also shown (FIG. 18F).

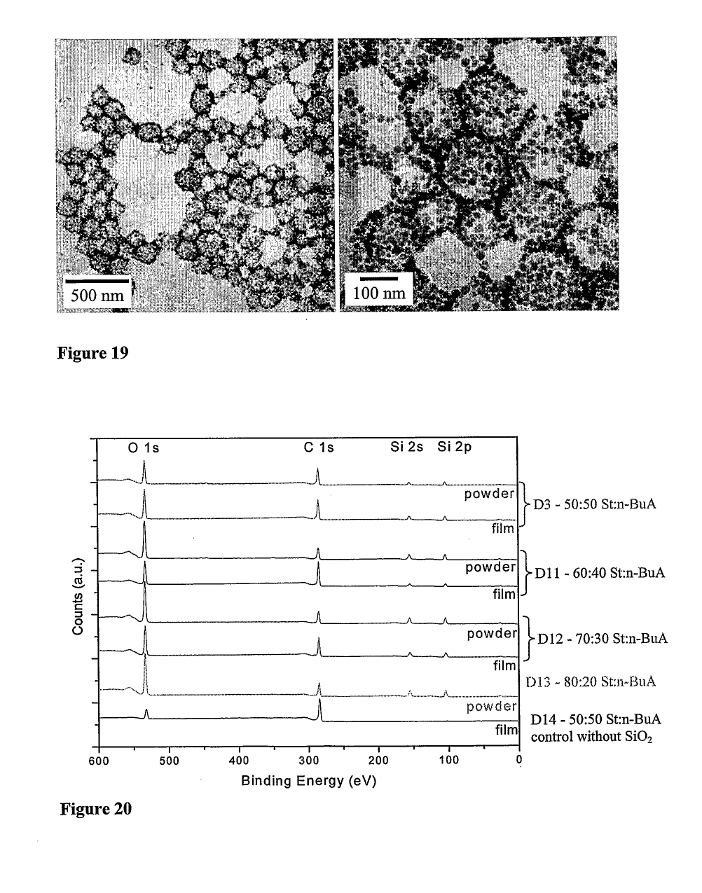

FIG. 19 shows TEM images obtained at two different magnifications for a calcined P(St-n-BuA)/SiO₂ nanocomposite (entry D3 in Table 9) at 550° C. This led to pyrolysis of the copolymer component, leaving ill-defined silica shells.

FIG. 20 shows XPS survey spectra recorded for various P(St-n-BuA)/SiO₂ nanocomposites before (freeze-dried) and after film-formation, as well as a copolymer latex control.

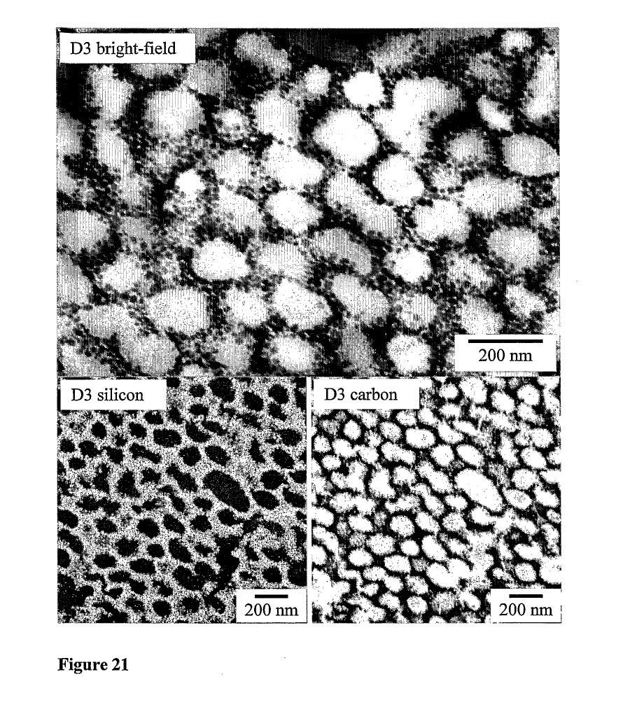

FIG. 21 shows TEM images of ultramicrotomed P(St-n-BuA)/SiO₂ nanocomposite particles (entry D3 in Table 9).

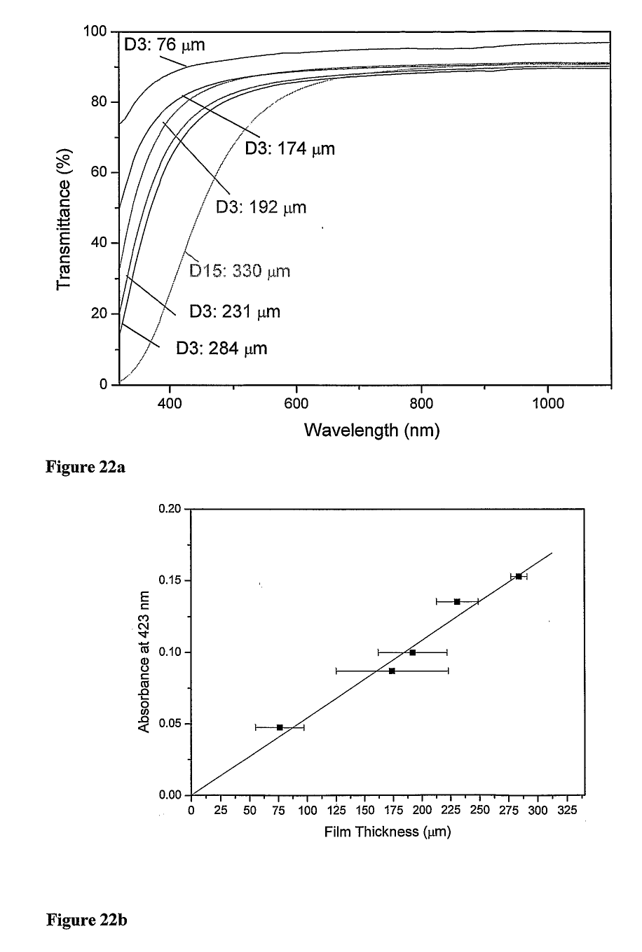

FIG. 22a shows transmission mode uv-visible absorption spectra recorded for P(St-n-BuA)/SiO₂ nanocomposite films prepared from sample D3 with various thicknesses. FIG. 22b shows the expected linear relationship between absorbance (λ=423 nm) and film thickness

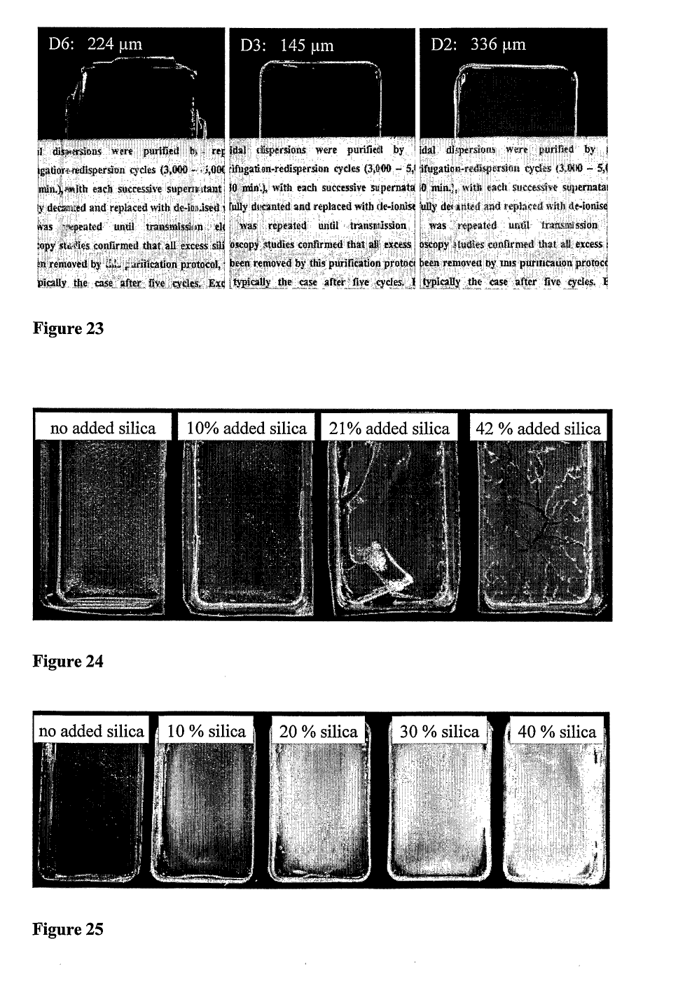

FIG. 23 shows digital photographs obtained for three P(St-n-BuA)/SiO₂ nanocomposite films containing around 40 wt % of silica cast at room temperature

FIG. 24 shows digital photographs of nanocomposite films (thickness 200′±41 μm) prepared from nanocomposite dispersion D3 using various percentages of added excess silica.

FIG. 25 shows digital photographs of nanocomposite films (film thickness 302±53 μm) prepared from mixtures of a cationic 50:50 St-n-BuA copolymer latex with various amounts of added silica sol. Images were recorded with the films still in their plastic moulds.

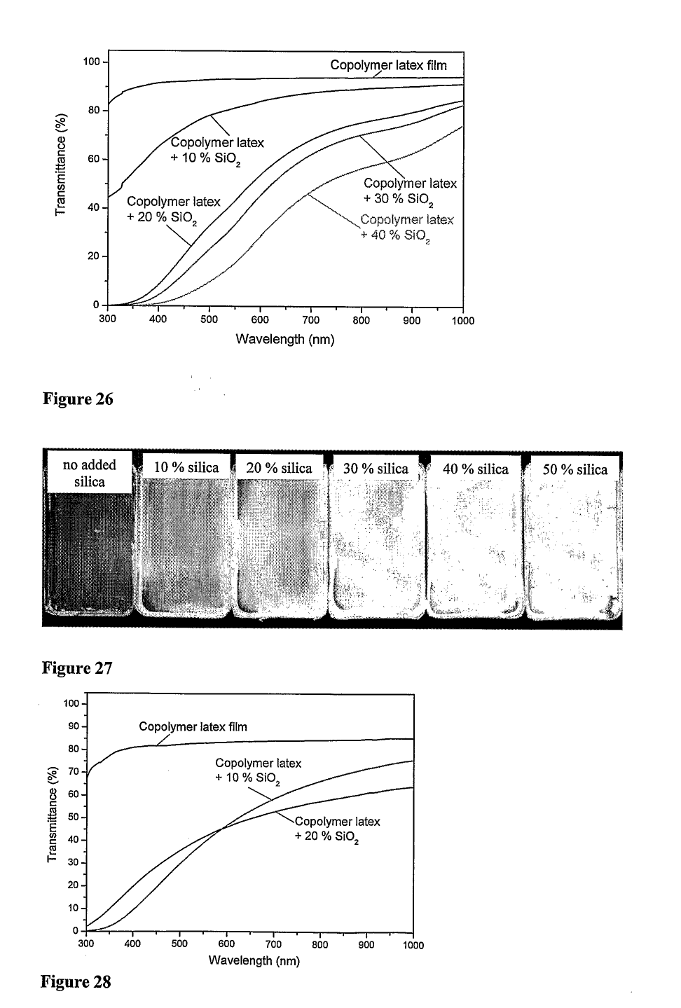

FIG. 26 shows transmittance measurements by uv-visible spectroscopy on the cationic copolymer latex films with and without various amounts of added silica sol.

FIG. 27 shows digital photographs of nanocomposite films prepared from mixtures of an anionic copolymer latex with various amounts of added silica sol. Images were recorded for films still in their plastic moulds.

FIG. 28 shows transmittance measurements obtained by uv-visible spectroscopy for the anionic copolymer latex films with and without various amounts of added silica sol. Addition of silica sol led to drastically reduced transparency in all cases.

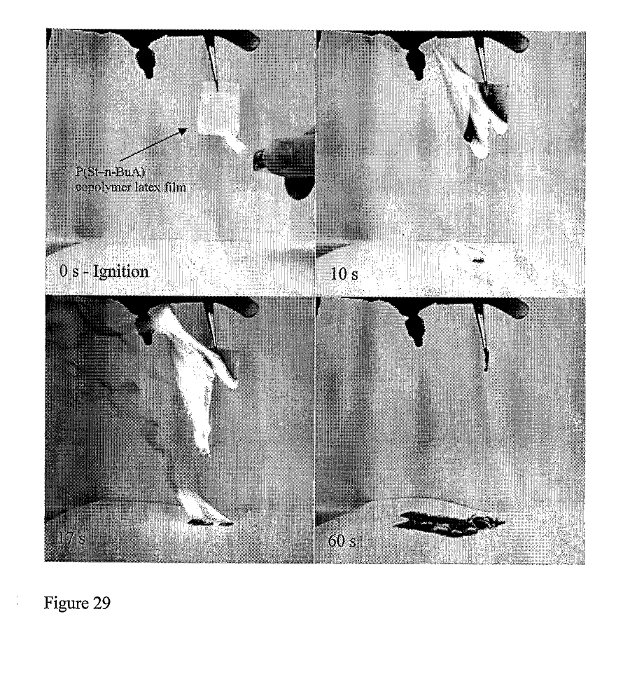

FIG. 29 shows digital photographs of the burning behaviour of a P(St-n-BuA) copolymer latex film recorded at different times.

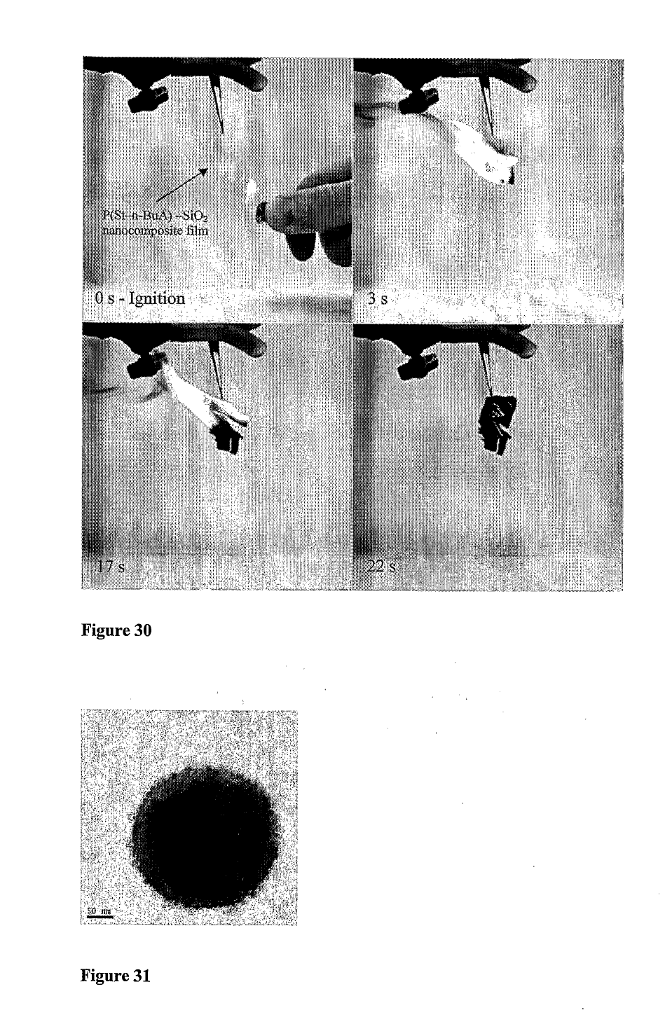

FIG. 30 shows digital photographs of the burning behaviour of a 50:50 P(St-n-BuA)/SiO₂ nanocomposite film (entry D7 in Table 9) recorded at different times.

FIG. 31 shows a TEM picture of an individual PSt/SiO₂ nanocomposite particle according to Example 45;

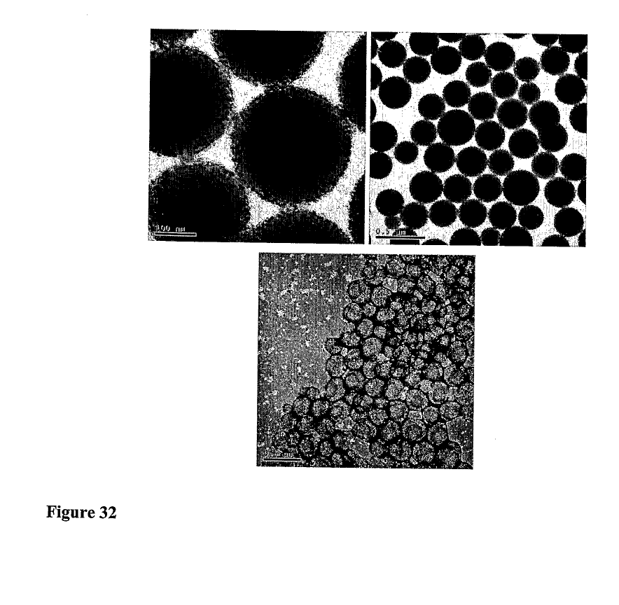

FIG. 32 shows TEM images of purified non film-forming PSt/SiO₂ nanocomposite particles, sample no. 5 (example 49) (top left and top right) and TEM images of the same sample after calcination on the TEM grid at 550° C. (bottom).

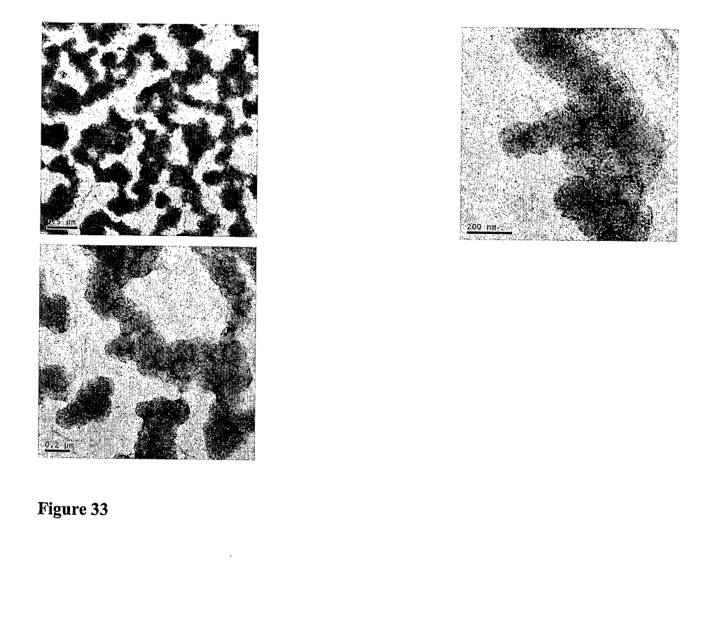

FIG. 33 shows TEM pictures of purified film-forming P(St-n-BuA)/SiO₂ nanocomposite particles (sample no. 9, Example 71).

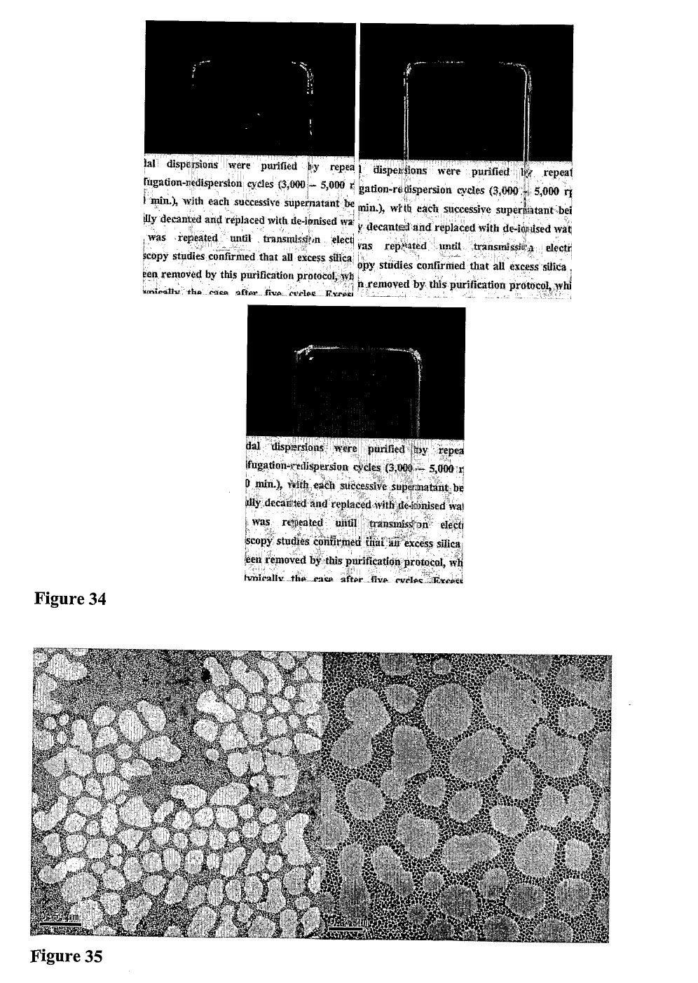

FIG. 34 shows P(St-n-BuA)/SiO₂ nanocomposite films prepared from sample no. 9 (Example 71) with different thicknesses (top left: 174 μm, top right: 249 μm, bottom: 358 μm).

FIG. 35 shows TEM images of P(n-BuA)-silica nanocomposite particles (Table 14, run 6)

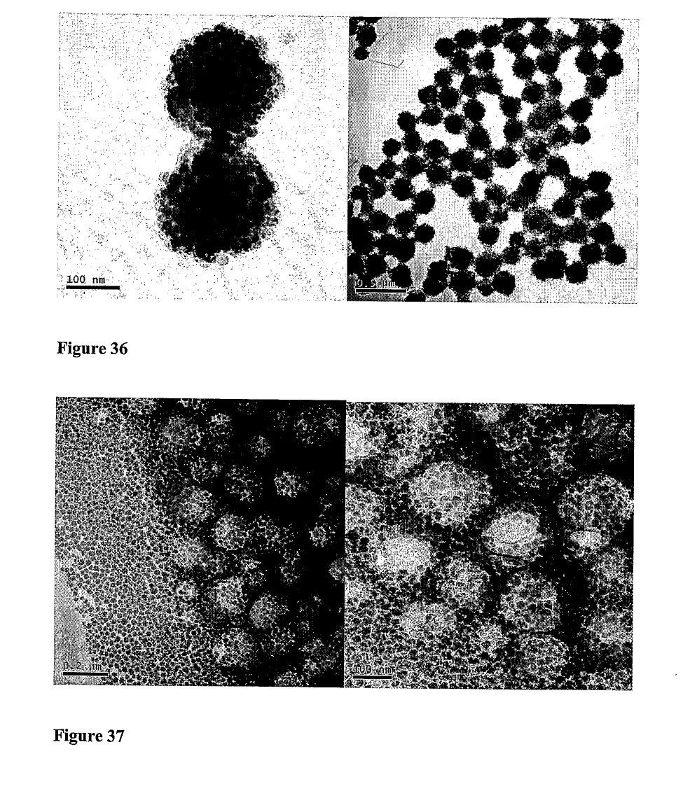

FIG. 36 shows TEM images of P(MMA)-silica nanocomposite particles (Table 15, run 7) prepared by emulsion polymerization using a cationic AIBA initiator and an commercial aqueous Bindzil CC40 silica sol.

FIG. 37 shows TEM images of P(MMA-co-n-BuA)-silica nanocomposite particles prepared by emulsion copolymerization of methyl methacrylate and n-butyl acrylate (1:1 ratio) using a cationic AIBA initiator and a commercial aqueous Bindzil CC40 silica sol

### EXAMPLES

The following Examples are illustrative of the invention. FIG. 6 shows in general terms a reaction scheme for forming the composite particles according to the invention.

### Example 1

### (Bindzil® CC 40) and Styrene (Typical Synthesis Protocol)

A 100 ml one-necked flask equipped with a magnetic flea was charged at 20° C. with 36.6 g of deionized water and 5.4 g of aqueous Bindzil® CC 40 silica sol. This sol is an epoxysilane-modified silica sol available from EKA Chemicals AB, Sweden. According to the manufacturer, it has a solids content of 40% silica by weight and a mean diameter of 12 nm. However, the inventors' own analyses suggest a solids content of 37 wt. % and a mean diameter of 19 nm. The pH of this aqueous reaction medium was 8.9. Then 5.0 g of styrene was added and the reaction mixture was subsequently degassed by five evacuation-nitrogen purge cycles and heated to 60° C. with stirring at 250 rpm. 50 mg of AIBA cationic azo initiator dissolved in 5.0 g of degassed deionised water was added to the stirred reaction medium at 60° C. to start the polymerisation. The reaction mixture was stirred at 60° C. for 24 h and subsequently cooled to room temperature.

Excess silica sol was removed by repeated centrifugation-redispersion cycles (at 7000 rpm for 30 minutes per cycle). After eight cycles, no excess (non-adsorbed) silica particles could be observed by transmission electron microscopy (TEM) studies. TEM also confirmed the formation of well-defined polystyrene-silica nanocomposite particles with a mean number-average diameter of approximately 310 nm (see FIG. 1 in which it can be seen that substantially the whole surface of the polymer core is covered by a shell, comprising at least one layer of silica particles). The mean silica content of the nanocomposite particles was determined to be 24 wt. % by thermogravimetric analysis using a Perkin-Elmer Pyris 1 TGA instrument (see FIG. 4). Oven-dried polystyrene-silica nanocomposites were heated in air from 30° C. to 800° C. at a heating rate of 10° C. min⁻¹. The remaining residues were assumed to be silicon dioxide (SiO₂). Dynamic light scattering studies and aqueous electrophoresis measurements were performed using a Malvern Zetasizer Nanoseries ZS instrument. Hydrodynamic particle diameters were measured for dilute solutions. Zeta potentials were determined in 1 mM aqueous KCl with the solution pH being adjusted using KOH and/or HCl. A typical hydrodynamic (intensity-average) particle diameter obtained by DLS was 333 nm. The polydispersity index of this dispersion was 0.057, which suggests a relatively narrow particle size distribution. Aqueous electrophoresis measurements indicated negative zeta potentials over a wide pH range, similar to the behaviour of the pristine Bindzil CC 40 silica sol (see FIG. 5). This suggests that the silica sol is located on the particle surface.

The silica aggregation efficiency for this nanocomposite synthesis was estimated to be 79% from the silica content of the purified polystyrene-silica nanocomposite particles obtained by thermogravimetric analysis, assuming 100% monomer conversion and using the following formula:

$$η = \frac{s \cdot {m}_{monomer}}{( 1 - s ) \cdot {m}_{silica}} \cdot 100 \%$$

where η is the silica aggregation efficiency, s is the silica content, and mₘₒₙₒₘₑᵣ and m_{silica} are the initial masses of monomer and silica, respectively.

Typical TEM images obtained for PSt-silica nanocomposite particles prepared using the Bindzil CC 40 silica sol are shown in FIGS. 1A and 1B. The presence of the Bindzil silica particles on the surface of these nanocomposite particles can be clearly observed.

### Examples 2 to 13

The synthesis described in Example 1 above was repeated with variations in the conditions and amounts of materials. The results are summarised in Summary Table 1.

SUMMARY TABLE 1
Effect of varying the synthesis conditions described in
Example 1 (the emulsion polymerisation of styrene in the presence of an
epoxysilane-functionalised aqueous silica sol Bindzil © CC40
with a cationic AIBA azo initiator).

| | | Initiator | | Particle | | Silica | Silica |
|---|---|---|---|---|---|---|---|
| Example | Silica Mass | Mass | Temp | Diameter | | Content | Aggregation |
| No. | (g) | (mg) | (° C.) | (nm) | PDI | (wt. %) | Efficiency (%) |
| 2 | 1.3 | 50 | 60 | 444 | 0.071 | 28 | 99 |
| 3 | 1.5 | 50 | 60 | 471 | 0.081 | 29 | 95 |
| 4 | 2.0 | 50 | 60 | 333 | 0.057 | 24 | 79 |
| 5 | 4.0 | 50 | 60 | 308 | 0.055 | 26 | 44 |
| 6 | 6.0 | 50 | 60 | 297 | 0.057 | 22 | 24 |
| 7 | 8.0 | 50 | 60 | 283 | 0.104 | 24 | 20 |
| 8 | 4.0 | 100 | 60 | 352 | 0.073 | 34 | 64 |
| 9 | 4.0 | 150 | 60 | 371 | 0.094 | 36 | 70 |
| 10 | 2.0 | 50 | 65 | 664 | 0.155 | 27 | 92 |
| 11 | 2.0 | 50 | 70 | 616 | 0.209 | 25 | 83 |
| 12 | 2.0 | 50 | 80 | 492 | 0.216 | 23 | 75 |
| 13 | 2.0 | 50 | 90 | 677 | 0.130 | 20 | 63 |

From Table 1, it is clear that a lower silica sol concentration generally leads to increased silica incorporation efficiency and higher silica contents, and tends to produce larger PSt-silica nanocomposite particles. An increase in initiator concentration generally leads to larger particles and lower silica incorporation efficiencies. Raising the polymerisation temperature generally leads to broader particle size distributions and lower silica incorporation efficiencies.

### Example 14

### (Bindzil® CC 30) and Styrene (Typical Synthesis Protocol)

A 100 ml one-necked flask equipped with a magnetic flea was charged at 20° C. with 35.1 g of deionized water and 6.9 g of aqueous Bindzil® CC 30 silica sol. Bindzil® CC 30 is an epoxysilane-modified silica sol available from EKA Chemicals AB, Sweden. According to the manufacturer, it has a solids content of 30% silica by weight and a mean diameter of 7 nm. However, the inventors' own analyses suggest a solids content of 29 wt. % and a mean diameter of 12 nm. The pH of this aqueous reaction medium was 8.9. Then 5.0 g of styrene was added and the reaction mixture was subsequently degassed by five evacuation-nitrogen purge cycles and heated to 60° C. with stirring at 250 rpm. 50 mg of AIBA cationic azo initiator dissolved in 5.0 g of degassed deionized water was added to the stirred reaction medium at 60° C. to start the polymerisation. The reaction mixture was stirred at 60° C. for 24 h and subsequently cooled to room temperature.

Excess silica sol was removed by centrifugation-redispersion cycles (at 7,000 rpm for 30 minutes per cycle). No excess silica particles could be observed by TEM studies after six cycles. TEM analyses confirmed the formation of PSt-silica nanocomposite particles having a mean number-average diameter of approximately 290 nm. The silica content of these PSt-silica nanocomposite particles was determined to be 23 wt. % by thermogravimetric analysis as described for Example 1 above (see FIG. 4). DLS was used to obtain a hydrodynamic particle diameter of 305 nm and a polydispersity index of 0.028 (see Example 1 for protocol details). Aqueous electrophoresis measurements indicated negative zeta potentials over the whole pH range investigated, which is similar to the behaviour of the pristine silica sol (see FIG. 5). This suggests that the silica sol is located on the nanocomposite particle surface. The silica aggregation efficiency for this nanocomposite synthesis was estimated to be 75% from the silica content determined by thermogravimetric analysis, assuming 100% monomer conversion, as described for Example 1 above.

Typical TEM images obtained for polystyrene-silica nanocomposite particles prepared using the Bindzil CC 30 silica sol are shown in FIGS. 2A and 2B. The presence of the Bindzil silica particles on the surface of these nanocomposite particles can be clearly observed.

### Summary Table 2 for Examples 4 and 14 Above

| Example | Silica content | Silica aggregation | Hydrodynamic | |
|---|---|---|---|---|
| No. | (TGA) | efficiency | Diameter | PDI |
| Example 4 | 24% | 79% | 333 nm | 0.057 |
| Example 14 | 23% | 75% | 305 nm | 0.028 |

### Influence of Silica Sol Concentration

### Bindzil CC40 and PSt

To investigate improvements in the silica incorporation efficiency, the initial silica concentration was systematically varied. Syntheses were conducted following the protocol described above with amounts of the 19 nm Bindzil CC40 silica sol ranging from 1.0 g to 8.0 g (based on dry weight) in a fixed 50 ml reaction volume. TEM images of representative polystyrene/silica nanocomposites, after the cleaning procedure are shown in FIGS. 10A-10E and the corresponding DCP curves are shown in FIG. 10F.

A summary of data for this set of experiments with respect to silica content, silica incorporation efficiency and particle diameter for various initial silica sol concentrations is given in Table 3.

This set of experiments suggests that lower initial silica concentrations are beneficial in terms of high silica incorporation efficiency. However, particularly, low initial silica concentrations may possibly compromise colloidal stability, leading to incipient flocculation.

TABLE 3
Summary of the effect of varying the initial Bindzil CC40 silica concentration on various nanocomposite particle properties in the
emulsion polymerisation of styrene with cationic AIBA at 60° C. for 24 h.

| | | Initial | Particle | Silica | Silica Incorporation | Silica Incorporation | Hydrodynamic | Weight Average |
|---|---|---|---|---|---|---|---|---|
| Example | | Silica | Density^{a} | Content^{b} | Efficiency [TGA] | Efficiency | Particle Diameter^{c} | Particle Diameter^{d} |
| No | No | Mass (g) | (g cm⁻³) | (wt %) | (%) | [Centrifugation] (%) | (nm) | (nm) |
| 15 | C25 | 1.0 | 1.19 | 18 | 97 | 94 | 504 (0.123) | 379 ± 133 |
| 16 | C26 | 1.25 | 1.20 | 21 | 92 | 95 | 453 (0.147) | 354 ± 129 |
| 17 | C27 | 1.5 | 1.22 | 22 | 76 | 90 | 510 (0.229) | 353 ± 43 |
| 18 | C1 | 2.0 | 1.22 | 24 | 73 | 85 | 333 (0.057) | 285 ± 38 |
| 19 | C20 | 3.0 | 1.25 | 27 | 50 | 50 | 330 (0.060) | 281 ± 38 |
| 20 | C3 | 4.0 | 1.23 | 26 | 37 | 39 | 308 (0.055) | 269 ± 43 |
| 21 | C4 | 6.0 | 1.19 | 22 | 20 | 24 | 297 (0.057) | 278 ± 40 |
| 22 | C5 | 8.0 | 1.22 | 24 | 17 | 25 | 283 (0.104) | 280 ± 48 |

^{a}As determined by helium pycnometry.
^{b}Determined by TGA.
^{c}As measured by dynamic light scattering, PDI values are given in brackets.
^{d}As measured by disc centrifuge photosedimentometry.

### Influence of Polymerisation Temperature

### Bindzil CC40 and PSt

The influence of polymerisation temperature was studied at two constant silica concentrations. One series of experiments was carried out with 1.5 g of initial silica sol, (noting that at this level in experiments above a silica incorporation efficiency of more than 75% with narrow particle size distributions is achieved). The second set of experiments was conducted using 2.0 g initial silica sol. Although the silica incorporation efficiency may not be optimised at this higher silica mass, it was considered likely to provide a wider margin of error in terms of size distribution and incipient flocculation.

The initial temperature at which the polymerisations were conducted was 60° C. Lowering this temperature seemed to be not particularly interesting as the rate of decomposition of the initiator would be significantly slower and extended over a much longer period of time. Half-lives of the AIBA initiator according to the manufacturer are 420 min at 60° C., 200 min at 65° C., 125 min at 70° C., 30 min at 80° C. and 1.6 min at 90° C. The temperature was therefore increased in either 5° C. or 10° C. increments up to 90° C. The results are summarised in Table 4.

There is no easily identifiable trend in particle properties in these two sets of nanocomposite syntheses. With increasing temperature there is a decrease in silica incorporation efficiency. Regardless of the initial amount of silica, the particle density seems to vary only slightly between 1.19 and 1.24 g cm⁻³ and within this variation no temperature dependence is apparent. Similarly, there seems to be no significant influence on the particle diameter, although generally broader particle size distributions were obtained at higher temperatures, as judged by both DCP and DLS. However, broadening of the particle size distribution was not confirmed by TEM images which were obtained. Thus the increase in polydispersity index may possibly be due to incipient particle flocculation or aggregation observed for higher reaction temperatures.

TABLE 4
Summary of the effect of varying the reaction temperature on the synthesis of
polystyrene/silica nanocomposite particles in the polymerisation of styrene with
cationic AIBA in the presence of a 19 nm commercial aqueous silica sol
(Bindzil CC40), at two constant initial silica amounts of 1.5 and 2.0 g.
Amount of styrene was 5.0 g, polymerisation was continued for 24 h.

| | | | | | | | Silica Incorporation | | Weight average |
|---|---|---|---|---|---|---|---|---|---|
| | | | | Particle | Silica | | Efficiency | Hydrodynamic | Particle |
| | | Silica | Temp | Density^{a} | Content^{b} | Silica Incorporation | [centrifugation] | Particle Diameter^{c} | Diameter^{d} |
| Example | No. | (g) | (° C.) | (g cm⁻³) | (wt. %) | Efficiency [TGA] (%) | (%) | (nm) | (nm) |
| 23 | C21 | 1.5 | 60 | 1.24 | 25 | 95 | 99 | 408 (0.012) | 325 ± 44 |
| 24 | C22 | 1.5 | 70 | 1.23 | 26 | 92 | 98 | 435 (0.058) | 336 ± 57 |
| 25 | C23 | 1.5 | 80 | 1.21 | 22 | 71 | 76 | 472 (0.189) | 321 ± 50 |
| 26 | C24 | 1.5 | 90 | 1.23 | 24 | 73 | 76 | 514 (0.201) | 320 ± 35 |
| 27 | C1 | 2.0 | 60 | 1.22 | 24 | 73 | 85 | 333 (0.057) | 285 ± 38 |
| 28 | C7 | 2.0 | 65 | 1.24 | 27 | 75 | 94 | 664 (0.155) | 314 ± 43 |
| 29 | C8 | 2.0 | 70 | 1.23 | 25 | 70 | 73 | 616 (0.209) | 317 ± 39 |
| 30 | C9 | 2.0 | 80 | 1.22 | 23 | 60 | 62 | 492 (0.216) | 322 ± 38 |
| 31 | C10 | 2.0 | 90 | 1.19 | 20 | 53 | 65 | 677 (0.130) | 347 ± 42 |

^{a}As determined by helium pycnometry.
^{b}Determined by TGA.
^{c}As measured by dynamic light scattering, PDI values are given in brackets.
^{d}As measured by disc centrifuge photosedimentometry.

Nevertheless, it can be suggested in view of these results that the highest silica incorporation efficiencies and lowest polydispersity indices (corresponding to good colloidal stability) are obtained at about 60° C., rather that at higher temperatures. With respect to AIBA initiator half-lives noted above this is quite reasonable as at 60° C. the initiator half-life, of 420 minutes is in the same region as the polymerisation time, whereas at higher temperatures the initiator half-lives are drastically shorter.

### Influence of pH

### Bindzil CC40 and PSt

The effect of varying pH was investigated. All previous syntheses were carried out at the ‘natural’ pH of 8.9 that results when the Bindzil CC40 silica sol is diluted with water. Colloidal nanocomposite syntheses previously reported in the literature using aqueous silica sols have been commonly conducted at pH 9.8 to 10.0. At this basic pH the silica sol is highly anionic which ensures good colloidal stability. Variation of the solution pH was examined using the previously established formulation. These results are summarised in Table 5.

It seems as if higher silica incorporation efficiencies are obtained when the pH is lowered, which subsequently leads to higher silica contents. On the other hand, on lowering the pH the hydrodynamic particle diameters and the polydispersity indices both increase, which suggests that less stable particles may be formed at lower pH. This may be attributed to a reduced colloidal stability of the silica sol at lower pH, bearing in mind that these silica particles on the nanocomposite particle surface are responsible for the overall colloidal stability. This effect is less obvious from the DCP weight-average particle, diameter (see FIG. 11) which typically varies only slightly between 275 and 304 nm.

The DCP curve for the nanocomposite particles prepared at pH 7.0 seems to provide some evidence for a bimodal particle size distribution, which may be related to some non-spherical particles which have been observed by TEM.

TABLE 5
Summary of the influence of varying the solution pH on polystyrene/silica nanocomposite properties
prepared by emulsion polymerisation of styrene initiated with cationic AIBA initiator at 60° C.
in the presence of 2.0 g of the aqueous Bindzil CC40 silica sol.

| | | | | | Silica | Silica | | |
|---|---|---|---|---|---|---|---|---|
| | | | | | Incorporation | Incorporation | | |
| | | | Particle | Silica | Efficiency | Efficiency | Hydrodynamic | Weight Average |
| Example | Sample | | Density^{a} | Content^{b} (wt | [TGA] | [centrifugation] | Particle Diameter^{c} | Particle Diameter^{d} |
| No | No | pH | (g cm⁻³) | %) | (%) | (%) | (nm) | (nm) |
| 32 | C15 | 10.0 | 1.19 | 20 | 51 | 52 | 205 (0.041) | 304 ± 42 |
| 33 | C1 | 8.9 | 1.22 | 24 | 73 | 85 | 333 (0.057) | 285 ± 38 |
| 34 | C16 | 8.0 | 1.26 | 28 | 73 | 80 | 426 (0.179) | 280 ± 33 |
| 35 | C17 | 7.0 | 1.26 | 27 | 75 | 80 | 370 (0.084) | 275 ± 43 |
| 36 | C18 | 5.0 | 1.26 | 28 | 80 | 91 | 445 (0.211) | 283 ± 37 |

^{a}As determined by helium pycnometry.
^{b}Determined by TGA.
^{c}As measured by dynamic light scattering, PDI values are given in bracket.
^{d}As measured by disc centrifuge photosedimentometry.

### AIBA Absorption Characteristics

It has been shown in the literature that the cationic AIBA initiator is most likely adsorbed onto the aqueous anionic silica sol. Accordingly, a Langmuir-type isotherm for AIBA adsorption onto the aqueous Bindzil CC40 silica sol was established using the depletion method coupled with uv-visible spectroscopy. Samples containing identical amounts of silica sol were mixed with varying amounts of the AIBA initiator, which was then allowed to adsorb at room temperature (20° C.) for 60 minutes. Thereafter, these dispersions were centrifuged at 20,000 rpm for 4 h while the temperature in the centrifuge tube was kept constant at 20° C. The rather high centrifugation rate was required to ensure efficient silica sedimentation, while the temperature was kept at 20° C. to prevent thermal decomposition of the initiator. A calibration curve was constructed for AIBA in water using its characteristic absorbance at 368 nm. After centrifugation, the uv-visible spectrum of each supernatant was recorded.

The adsorbed amount was then determined from the difference between the amount of AIBA added at the beginning and the amount of AIBA remaining in solution after adsorption. These adsorbed amounts were then plotted against the equilibrium AIBA concentration, resulting in the adsorption isotherm shown in FIG. 12.

This adsorption isotherm suggests that the maximum adsorbed amount of AIBA on the Bindzil CC40 silica sol is 6.8 mg g⁻¹, or 0.045 mg m⁻². This latter value can be compared to that of 0.028 mg m⁻² reported for AIBA adsorption on a methanolic silica sol and 0.050 mg m⁻² reported for an aqueous Klebosol silica sol in the literature. The value for the Klebosol silica sol is very similar, whereas the value for the methanolic silica sol is somewhat lower. Comparing these data with an adsorbed amount of 0.25 mg m⁻² for an unmodified Nyacol 2040 silica sol suggests that the presence of the surface glycerol groups in case of the Bindzil CC40 (and the likely presence of non-hydrolysed alkoxy groups in the case of the methanolic silica sol) reduces the number of surface anionic silanol groups and hence the negative surface charge. This leads to a lower extent of adsorption compared to the unmodified Nyacol 2040 silica sol. Nevertheless, the adsorbed amount of 0.045 mg m⁻² still corresponds to approximately 114 AIBA molecules per 19 nm Bindzil CC40 silica particle.

After having determined a maximum AIBA adsorbed amount of 6.8 mg g⁻¹ from the adsorption isotherm, several syntheses were conducted using this apparent optimum

TABLE 6
Influence of varying the AIBA initiator/silica mass ratio and the silica/monomer mass ratio on the nanocomposite
particle properties in the emulsion polymerisation of styrene at 60° C. for 24 h.

| | | | | | | | | | Hydro- | Weight |
|---|---|---|---|---|---|---|---|---|---|---|
| | | | | | | | Silica | Silica | dynamic | Average |
| | | Initiator | Silica | AIBA/SiO₂ | Particle | Silica | Incorporation | Incorporation | Particle | Particle |
| | Sample | Mass | Mass | mass | Density^{a} | Content^{b} | efficiency | Efficiency | Diameter^{c} | Diameter^{d} |
| Example | No | (mg) | (g) | ratio | (g cm⁻³) | (wt %) | [TGA] (%) | [Centr.] (%) | (nm) | (nm) |
| 37 | C28 | 4 | 2.0 | 2 | 1.19 | 23 | 61 | 62 | 236 (0.082) | 249 ± 172 |
| 38 | C29 | 8 | 2.0 | 4 | 1.17 | 19 | 38 | 41 | 301 (0.088) | 285 ± 59 |
| 39 | C30 | 12 | 2.0 | 6 | 1.23 | 27 | 82 | 92 | 200 (0.034) | 159 ± 56 |
| 40 | C12 | 10.5 | 1.5 | 7 | 1.14 | 13 | 38 | 40 | 355 (0.035) | 293 ± 42 |
| 41 | C14^{e} | 14 | 2.0 | 7 | 1.15 | 14 | 35 | 34 | 364 (0.041) | 302 ± 38 |
| 42 | C11 | 14 | 2.0 | 7 | 1.24 | 26 | 83 | 95 | 208 (0.025) | 164 ± 29 |
| 43 | C13 | 21 | 3.0 | 7 | 1.17 | 16 | 26 | 23 | 324 (0.068) | 276 ± 43 |
| 44 | C1 | 50 | 2.0 | 25 | 1.22 | 24 | 73 | 85 | 333 (0.054) | 285 ± 38 |

^{a}As determined by helium pycnometry,
^{b}Determined by TGA,
^{c}As measured by dynamic light scattering, PDI values are given in brackets.
^{d}As measured by disc centrifuge photosedimentometry,
^{e}All added at the beginning.

initiator to silica mass ratio with a view to achieving an optimum silica incorporation efficiency, since essentially all of the cationic initiator is electrostatically adsorbed on the anionic silica particles, with little or no free initiator in solution. The amount of styrene monomer was kept constant at 5.0 g, which in combination with the optimum initiator to silica ratio resulted in rather low initiator amounts based on styrene. Therefore two syntheses were conducted at this constant silica to initiator mass ratio but by varying the silica amount, which thereby also increased the initiator to styrene mass ratio. A summary of these experiments is shown in Table 6 and TEM images are shown in FIG. 13.

Comparing sample numbers C12, C11, C13 with initial silica amounts of 1.5, 2.0 and 3.0 g respectively indicates an optimum silica incorporation efficiency of 83% at an initial silica amount of 2.0 g (C11). In contrast, the other syntheses only resulted in silica incorporations of either 28 or 38%. Comparing this to entry C14, where the only difference to entry C11 is that the initiator was added at the beginning at room temperature (as opposed to adding it last after the whole reaction mixture has been heated to 60° C.) suggests that even if the initiator/silica mass ratio and the initial silica concentration seems to be optimised, the method of initiator addition may have a significant effect on the final particle characteristics.

This observation is rather surprising, since it might be thought that adding the cationic initiator at the beginning and allowing it to adsorb onto the anionic silica sol would favour surface polymerisation from the silica surface. However the experimental results do not support this hypothesis and it seems that nanocomposite particle formation is likely to involve other factors.

To obtain further information regarding the influence of the initiator/silica mass ratio another set of syntheses was carried out in which the amount of cationic AIBA initiator was varied below its optimum amount of 7 mg g⁻¹. Reactions were conducted at 2.0, 4.0 and 6.0 mg g⁻¹ in order to minimise the amount of free initiator in solution. However, only the reaction conducted at 6 mg g⁻¹ led to a similarly high incorporation efficiency.

At low initiator/silica mass ratios it appears that nanocomposite particles exist that contain-relatively few silica particles. Moreover it seems that some nanocomposite particles do not contain any silica at all. With an increasing initiator/silica mass ratio, the number of silica particles increases and at a value of 7 mg g⁻¹ all particles seem to be more or less homogeneously covered with silica particles.

Surprisingly, in view of the apparent optimum ratio indicated above, similarly high incorporation efficiencies have also been obtained using a much higher initiator/silica mass ratio (see previous syntheses). There, the amount of initiator was chosen to be 1.0 wt % based on styrene monomer. This corresponds to an initiator/silica mass ratio of 25 mg g⁻¹, which is more than three times higher than the ‘optimum’ amount. This may indicate a possible weakness of the adsorption isotherm approach, that is, the difference in temperature at which the isotherm was determined and the temperature at which the polymerisations are actually carried out. However, there seems to be no straightforward way to determine the adsorption isotherm at 60° C., as the initiator would always decompose at this temperature.

In an attempt to resolve this problem, another method of assessing the influence of the AIBA initiator on the silica sol was investigated by measuring its zeta potential in the presence of various amounts of added initiator. In fact, constant amounts of an initiator stock solution were added to a silica sol of known concentration and its zeta potential was measured. The resulting graph is shown in FIG. 14. These measurements show a zeta potential reduction from initially −30 mV to approximately −11 mV on adding 20 mg AIBA per gram of silica. Further addition of AIBA only led to a minor additional reduction of the zeta potential, which always remained negative.

From this experiment, an AIBA/silica mass ratio of around 20 mg g⁻¹ corresponds to a plateau value or ‘knee’. It is suggested that this might explain why initiator/silica mass ratios of 25 mg g⁻¹ can also lead to high silica incorporation efficiencies: the reduction in zeta potential could favour silica adsorption onto the polystyrene particles.

### Particle Surface Characterisation

The surface compositions of the nanocomposite particles were characterised by aqueous electrophoresis and XPS. The Zeta potential measurements revealed that there is hardly any difference between the silica sols and the nanocomposite particles. Negative zeta potentials were observed over the whole pH range investigated and the polystyrene/silica nanocomposite particles show almost identical behaviour to the pristine silica sols. This suggests a silica-rich surface for the nanocomposite particles. Other nanocomposite particles prepared at various initial silica sol concentrations or silica/initiator mass ratios all show the same behaviour, which suggests that all samples, regardless of their synthesis parameters, have a silica-rich surface.

This finding was further substantiated by XPS measurements. With a sampling depth of 2-10 nm, XPS is a highly surface-specific technique. XPS survey spectra are shown in FIG. 15.

TABLE 7a
XPS elemental atomic percentages and the Si/C atomic ratios
determined from the corresponding core-line spectra for the two
silica sols (CC30 and CC40), three polystyrene/silica nanocomposite
samples (C1, C2 and C6 in Table 7b) and a polystyrene control sample
(PS entry C31 in Table 7b).

| | CC30 | CC40 | PS | C6 | C1 | C2 |
|---|---|---|---|---|---|---|
| C 1s | 12.9 | 12.0 | 99.2 | 26.9 | 31.2 | 80.7 |
| O1s | 55.4 | 54.6 | 0.6 | 45.0 | 43.0 | 11.3 |
| Si 2p | 31.7 | 33.4 | 0.1 | 28.1 | 25.9 | 8.0 |
| Si/C | 2.46 | 2.78 | 0.001 | 1.04 | 0.83 | 0.10 |

TABLE 7b
Summary of synthesis parameters, silica contents, silica incorporation efficiencies and particle diameters for selected PS-Si
nanocomposite particles and a latex control

| | | | | | | | | Silica | Silica | | | |
|---|---|---|---|---|---|---|---|---|---|---|---|---|
| | Initial | | | | | | | Incorporation | Incorporation | Particle | Particle | Particle |
| | Silica | Initiator | | | Monomer | Particle | Silica | Efficiency | Efficiency | Diameter | Diameter | Diameter |
| | Mass | Mass | Temp. | | Conversion | Density | Content | TGA/Conversion | Centrifugation | TEM | DCP | DLS |
| Entry No. | (g) | (mg) | (° C.) | pH | (%) | (g cm⁻³) | (wt %) | (%) | (%) | (nm) | (nm) | (nm) |
| C1 | 2.0 | 50.0 | 60 | 8.9 | 92 | 1.22 | 24 | 73 | 85 | 298 ± 41 | 285 ± 38 | 333 |
| | | | | | | | | | | | | (0.057) |
| C2 | 2.0 | 50.0 | 60 | 8.9 | 84 | 1.21 | 23 | 63 | 70 | 265 ± 26 | 256 ± 35 | 305 |
| | | | | | | | | | | | | (0.026) |
| C6 | 1.3 | 50.0 | 60 | 8.9 | 74 | 1.21 | 28 | 94 | 98 | 321 ± 32 | 315 ± 38 | 444 |
| | | | | | | | | | | | | (0.071) |
| C31 | none | 50.0 | 60 | 8.9 | 87 | 1.05 | — | — | — | — | — | 367 |
| | | | | | | | | | | | | (0.126) |

The presence of the two silicon signals in these survey spectra is further confirmation that the silica is present on the nanocomposite particle surface. Moreover, the additional presence of a more intense carbon signal compared to the carbon signal in the pure silica sample, suggests that the polystyrene component is also present at (or near) the particle surface. The indium signal at around 450 eV, which is very intense for sample C2 originates from the underlying substrate.

Core-line spectra recorded on these samples for the elements of interest (silicon, carbon, oxygen) can be used to quantify the individual atom percentages. These data are summarised in 7a. This again confirms that the silica sol also has a significant carbon signal due to its glycerol surface modification. In addition, these values can be used to calculate Si/C atomic ratios, which allows estimation of the silica concentration on the particle surface. For the samples prepared with the 19 nm silica sol these ratios are close to unity, revealing a significant amount of surface silica. The sample prepared with the smaller CC30 silica sol shows a much lower Si/C atomic ratio. However, taking account of the XPS sampling depth and the polydispersity of the silica sol, this merely reflects increased detection of the underlying polystyrene.

In addition to determining the silica surface concentration from the silicon signal, it is also possible to peak-fit the carbon signal and hence quantify the carbon species due to the silica glycerol modification. The carbon core-line spectra of the pure Bindzil CC silica particles reveal two carbon species, which correspond to C—C and C—O species. This peak-splitting can also be observed for the nanocomposites. Here the C—C feature reflects a combination of carbon due to the polystyrene and the glycerol silane species on the silica surface. The C—O signal, which is solely due to the modified silica, is also present and can be used to quantify the C—C contributions according to silica and polystyrene, respectively. Thus for the PSt/SiO₂ nanocomposites the surface silica concentration can be determined by either directly using the Si 2p signal or the C—O fraction of the C 1s signal. In addition the silica and polymer bulk weight ratios determined in the TGA experiment can be converted into atom percent and then compared to the aforementioned surface values. This is summarised in Table 8.

TABLE 8
Calculation of silica surface compositions from XPS measurements
using either Si 2p or C 1s signals. Comparison of XPS atomic percent
with bulk atomic percent calculated from TGA measurements and
determining surface Si at %/bulk Si at % ratios.

| | Surface Si | Surface Si | | Surface Si | Surface Si |
|---|---|---|---|---|---|
| | at % | at % | | at % | at % |
| | from Si 2p | from C 1s | Bulk Si at % | (Si 2p)/Bulk | (C 1s)/Bulk |
| No | signal | signal | from TGA | Si at % | Si at % |
| C1 | 25.9 | 24.5 | 5.7 | 4.5 | 4.3 |
| C6 | 28.1 | 33.1 | 6.7 | 4.2 | 4.9 |
| C2 | 8.0 | 5.1 | 5.4 | 1.5 | 0.9 |

These two methods of determining the surface Si at % by either taking the Si 2p signal or the C—O species of the C is signal agree rather well. Furthermore, using the TGA silica wt % and converting these values into at % allows direct comparison between surface and bulk silicon concentrations. For the two PS/SiO₂ nanocomposites (C1 and C6) prepared using the 19 nm Bindzil CC40 silica sol at either 2.0 g or 1.3 g initial silica amount, respectively, the surface Si/bulk Si atomic ratio is between 4.2 and 4.9 independent of which method was used to determine the surface Si at %. This confirms that the surface of these nanocomposite particles is rich in silica. For nanocomposite particles prepared using the smaller CC30 silica sol (entry C2) the surface Si/bulk Si atom ratio is closer to unity. If the Si 2p signal it used it is 1.5 and if the C₁s signal is used it is 0.9, suggesting that the bulk and surface silica concentrations are very similar. On first sight this might suggest a different particle morphology (e.g. currant bun), however, as the sampling depth of XPS is of the same order of magnitude as the silica particle diameter, the underlying polystyrene component is also detected for this sample. Therefore in this particular case the XPS silica/TGA silica atomic ratio can no longer be interpreted in terms of a surface/bulk ratio.

### Selective Removal of the Silica and Polystyrene Components

The silica content determined above suggests that it is very likely that the particles have a ‘core-shell’ morphology, with a polystyrene core and a silica shell. In contrast for a ‘raspberry’ particle morphology higher silica contents would be expected due to the additional silica inside the particles. Experiments were performed to selectively remove either the silica or the polystyrene component, respectively. TEM samples were calcined at 550° C., which leads to pyrolysis of the polystyrene component, leaving the thermally stable silica unaffected.

Representative TEM images before and after calcination are shown in FIG. 16. Images (a) and (b) show nanocomposite particles prepared with the 19 nm and the 12 nm silica sol, respectively. The same samples are shown after calcination at 550° C. in images (c) and (d). Thermal decomposition of the polystyrene led to the formation of hollow silica capsules consisting of either 19 nm or 12 nm silica particles. Some capsules did not retain their spherical morphology and showed some evidence of collapse. Removal of the silica component was achieved by treating the same samples with 50 wt % NaOH. This led to digestion of the surface-adsorbed silica particles, leaving the polystyrene component unaffected. The initially rough nanocomposite particle surface becomes noticeably smoother due to loss of the nano-sized silica particles. These experiments further confirm a ‘core-shell’ particle morphology.

DCP studies of an NaOH-etched PSt/SiO₂ nanocomposite (sample C1 in Table 1) reveal only a minor reduction in colloidal stability, in that the particle size distribution becomes slightly broader. However, cationic initiator fragments present on these etched particle surfaces are thought to be sufficient to retain the overall colloidal stability. Aqueous electrophoresis measurements of the same PSt/SiO₂ nanocomposite particles before and after etching of the silica reveal a significant change in zeta potential below pH 8 from negative to positive resulting in a shift in the isoelectric point from around pH 2 to pH 8.4. This is due to the cationic initiator fragments that were obscured by the surface silica becoming accessible after etching of the silica.

### ESI/TEM Studies

The core-shell morphology of these PSt/SiO₂ nanocomposite particles was further verified using the ESI/TEM technique in combination with ultramicrotomy, which provides element-specific information at high spatial resolution. In the carbon map shown in the bottom right-hand image of FIG. 17, the cross-sectioned particles (sample C1 in Table 7b) are easily visualised within the diffuse gray epoxy resin matrix. Bright halos with dark interiors within the gray matrix were also observed in the silicon map (see bottom left-hand image in FIG. 17). These images confirm that each nanocomposite particle has a well-defined ‘core-shell’ morphology, consisting of a purely polystyrene core surrounded by a thin shell of ultrafine silica particles.

Particles that appear smaller and ‘filled’ with silica do not represent a secondary population, these are merely parts of particles that have been sectioned off-centre, i.e. either near the top or the bottom of the particle.

### Bindzil® CC 30 and Styrene (Typical Synthesis Protocol)

Styrene monomer (5 g) and a desired amount of aqueous ultrafine Bindzil CC30 12 nm silica sol (as set out in Table 9) were added to a 100 ml single-necked round-bottomed flask containing about 35 g of deionised water and a magnetic stir bar. Then, additional deionised water was added to give a total mass of water of 41 g (including the water from the silica sol). A suba seal was attached to the flask, and oxygen was removed by five evacuation/nitrogen purge cycles while stirring. After that, the mixture was heated to 60° C. in an oil bath and the free radical azo initiator (50.0 mg, 1.0 wt % based on styrene), previously dissolved in water (4 g, the total amount of water now being 45 g) and degassed by purging with nitrogen through a needle for one minute, was added using a syringe and needle. The reaction mixture was allowed to stir at 250 rpm at that temperature for 24 h. The resulting milky-white dispersion was filtered through glass wool to remove possible precipitate or coagulum. Finally, purification was carried out by several centrifugation/redispersion cycles (Beckman centrifuge, model J2-21, rotor JA20), always carefully decanting the supernatant and replacing it with deionised water. The number of cycles carried out varied, with final purity being confirmed when no more excess silica was detected by TEM studies. The centrifuge speed and time was adjusted to suit the particle size determined beforehand, and was selected to be as low as possible to avoid sedimentation of the excess silica and to make redispersion as easy as possible. Typical set-ups ranged from 6000 to 9000 rpm for 50 minutes. Redispersion was done by placing the centrifuge tubes on Stuart SRT9 roller mixers overnight.

### Influence of Silica Sol Concentration (Bindzil® Cc 30 and Styrene)

As shown in Table 9, the amount of silica by mass was varied between 1.0 g and 6.0 g at a fixed 50 ml reaction volume. The minimum amount of silica needed to obtain a stable dispersion appeared to be 1.50 g SiO₂. The use of lower initial silica concentrations resulted in particle flocculation. A systematic reduction of the mean particle diameter with increasing silica concentration was observed, ranging from 400 nm to 270 nm (measured by DLS). Very low polydispersities (0.01 to 0.07) were achieved. Nanocomposite particle densities of 1.15 to 1.22 g·cm⁻³ were measured by helium pycnometry, with silica contents of 17 to 22 wt % being determined by TGA

TABLE 9

| | | | | | | | | | | | | silica |
|---|---|---|---|---|---|---|---|---|---|---|---|---|
| | | | | | | | | | silica | | | incorporation |
| | | | | | | | | | content | silica | silica | efficiency |
| | | | solids | | DLS particle | | DCP particle | | by | content | content | by |
| | Sample | silica | content | Conv. | diameter | | diameter | density | density | by TGA | elemental | centrifugation |
| Example | No. | mass (g) | (%) | (%) | (nm) | PDI | (nm) | (g · cm⁻³) | (%) | (%) | analysis | (%) |
| 45 | 1 | 1.00 | 9.94 | 81 | (flocculation) | 0.569 | x | x | x | x | x | 100 |
| 46 | 2 | 1.25 | 9.82 | 76 | (flocculation) | 0.275 | x | x | x | x | x | 100 |
| 47 | 3 | 1.50 | 10.32 | 76 | 399 | 0.059 | 275 ± 33 | 1.16 | 19 | 17 | 16 | 75 |
| 48 | 4 | 1.75 | 10.57 | 74 | 382 | 0.058 | 287 ± 48 | 1.18 | 23 | 21 | 19 | 70 |
| 49 | 5 | 2.00 | 11.48 | 79 | 331 | 0.014 | 256 ± 68 | 1.16 | 19 | 18 | 17 | 69 |
| 50 | 6 | 3.00 | 13.41 | 82 | 307 | 0.070 | 243 ± 30 | 1.17 | 21 | 20 | 19 | 40 |
| 51 | 7 | 4.00 | 14.96 | 82 | 289 | 0.038 | 227 ± 34 | 1.15 | 18 | 17 | 16 | 39 |
| 52 | 8 | 6.00 | 17.85 | 80 | 273 | 0.047 | 197 ± 28 | 1.22 | 28 | 22 | 21 | 29 |

measurements. Silica contents calculated from density measurements and elemental analysis correlate well with the observed TGA data.

A typical polystyrene/silica nanocomposite particle prepared using Bindzil CC30 (Example 45) is shown in FIG. 31,

### Silica Incorporation Efficiency

To determine silica incorporation efficiencies, the unpurified reaction solutions were centrifuged on a Beckmann J2-21 centrifuge at 8000 rpm for 20 minutes. The nanocomposite particles were completely sedimented while most of the silica particles remained colloidally dispersed. The gravimetric measurement of the supernatant solids content gave the amount of excess silica. Thus, given the solids content of the initial silica concentration in the reaction mixture, the silica incorporation efficiencies could be calculated. These efficiencies decreased from 75% to 29% with increasing initial silica concentration, confirming the expectation that higher silica concentrations lead to smaller aggregation efficiencies (i.e. more excess silica).

### Morphology

TEM images of purified PSt/silica nanocomposite particles are shown in FIG. 32. The particles have a spherical morphology with the ultrafine silica particles being clearly present at the surface, which suggests a ‘core-shell’ morphology.

Further investigation of the particle composition and morphology was carried out through calcination of dried nanocomposite particles on a TEM grid at 550° C. The polymer was completely pyrolysed and TEM analysis of this sample revealed well-defined, contiguous hollow silica shells (FIG. 32, bottom), which is again consistent with a ‘core-shell’ morphology.

Moreover, zeta potentials of the PSt/SiO₂ nanocomposite particles were negative from pH 11 to pH 2.5, which is very similar electrophoretic behaviour to that of the pristine 12 nm ultrafine silica sol. This again clearly suggests that the particles have a silica-rich surface.

### Styrene Co-Polymers

### Example 53

### (Bindzil® CC40) and P(St-co-n-BuA)

### Typical Synthesis Protocol

A 100 ml one-necked flask equipped with a magnetic flea was charged at 20° C. with 35.9 g of deionized water and 8.1 g of a 37 wt. % aqueous solution of the Bindzil® CC 40 silica sol. The pH of this aqueous reaction medium was 8.9. Then 2.5 g of styrene and 2.5 g of n-butyl acrylate were added and the reaction mixture was subsequently degassed by five evacuation-nitrogen purge cycles and heated to 60° C. with stirring at 250 rpm. 50 mg of cationic azo initiator (AIBA) dissolved in 4.0 g of degassed deionized water was added to the stirred reaction medium at 60° C. to start the polymerisation. The reaction mixture was stirred at 60° C. for 24 h and subsequently cooled to room temperature. The resulting milky-white colloidal dispersions were purified by repeated centrifugation-redispersion cycles (5,000-7,000 rpm for 30 min.) in a refrigerated centrifuge (5° C.), with each successive supernatant being carefully decanted and replaced with de-ionised water. Redispersion was achieved by agitation on a roller mixer for a few hours as sonication is usually accompanied by a rise in temperature which might lead to film-formation prior to redispersion. This was repeated until TEM studies confirmed that all excess silica sol had been removed by this purification protocol, which was typically the case after five cycles.

TEM analyses confirmed the formation of P(St-n-BuA)silica nanocomposite particles having a mean number-average diameter of approximately 160 nm. The silica content of these P(St-n-BuA)-silica nanocomposite particles was determined to be 41 wt. % by thermogravimetric analysis as described for Example 1 above (see FIG. 4). DLS was used to obtain a hydrodynamic particle diameter of 242 nm and a polydispersity index of 0.176 (see Example 1 for protocol details). Aqueous electrophoresis measurements indicated an isoelectric point at pH 6.5. The silica aggregation efficiency for this nanocomposite synthesis was estimated to be 99%, as calculated from the silica content determined by thermogravimetric analysis, which is notably higher than that achieved in the absence of n-butyl acrylate as second monomer.

The aqueous nanocomposite dispersion prepared according to this example forms a reasonably tough, transparent film on drying overnight at ambient temperature (20° C.). Typical TEM images obtained for these P(St-n-BuA)-silica nanocomposite particles prepared using the Bindzil CC 40 silica sol are shown in FIGS. 3A and 3B. The presence of the Bindzil silica particles on the surface of these nanocomposite particles can be clearly observed. Partial film formation of these nanocomposite particles seems to occur during TEM preparation.

### Influence of Silica Sol Mass

Investigations discussed above in relation to styrene only nanocomposite particles confirmed that the amount of initial silica sol has a significant effect on nanocomposite particle properties. Thus an increase in initial silica sol concentration generally led to a reduction in mean particle diameter, albeit accompanied by lower silica sol incorporation efficiencies. In the following examples a similar study was conducted using a film-forming 50:50 Pst/n-BuA comonomer mixture. The initial amount of silica was varied between 1.5 and 4.0 g in a 50 ml reaction volume. These results are summarised in Table 10 (entries D1 D7).

Like the previous studies of PSt/silica nanocomposite particles, an increase in silica incorporation efficiency at lower initial silica concentration can also be observed for the current film-forming protocol. Furthermore, the silica sol incorporation efficiencies are significantly increased: even at the highest initial silica sol concentration investigated of 4.0 g (entry D7 in Table 10) the silica incorporation efficiency is as high as 80%. Syntheses conducted at lower silica sol concentration led to almost complete silica incorporation. Another difference compared to the styrene homopolymerisation is the higher minimum amount of silica seemingly required to obtain stable nanocomposite particles (3.0 g) (entry D3). Below this minimum amount, in these particular examples, flocculation is occurring during the copolymerisation. A possible reason might be that, compared to the PSt/SiO₂ homopolymer nanocomposites, these copolymer-silica particle diameters are smaller which requires a larger number of silica particles to adsorb onto the higher surface area. TEM images of non-purified P(St-n-BuA)/SiO₂ nanocomposite samples and the corresponding DCP curves are shown in FIG. 18 and confirm that some excess free silica is visible at higher initial silica sol concentrations. Purification, and therefore accurate characterisation of the silica content, is more difficult for these film-forming nanocomposites. Centrifugation to remove excess silica sol was attempted at a moderate rate of sedimentation (no more than 8,000 rpm [5,018×g] for 30 minutes). The centrifuge chamber and rotor were cooled to about 5° C. in order to avoid film-formation of the sedimented particles.

TABLE 10
Summary of reaction parameters and sample characteristics of poly(styrene-n-butyl acrylate)/silica nanocomposite samples
prepared with a commercial 19 nm Bindzil CC40 silica sol and a cationic AIBA initiator. Polymerisations were conducted using 5.0 g of
monomer in 50 ml reaction volume and 50 mg AIBA at 60° C. for 24 hours.

| | | | | | | | Silica | | Number | Weight | |
|---|---|---|---|---|---|---|---|---|---|---|---|
| | | | | | | | Incorporation | Silica | Average | average | |
| | | Initial | | | | | Efficiency | Incorporation | Particle | Particle | Hydrodynamic |
| | | Silica | St:n-BuA | Monomer | Particle | Silica | from | Efficiency from | Diameter | Diameter | Particle Diameter |
| | Entry | Mass | mass | Conv^{a} | Density^{b} | Content^{c} | TGA/Conv | Centrif | TEM | DCP | DLS |
| Example | No. | (g) | ratio | (%) | (g cm⁻³) | (wt %) | (%) | (%) | (nm) | (nm) | (nm) |
| 54 | D1 | 1.5 | 50:50 | Floc | — | — | — | — | — | — | — |
| 55 | D2 | 2.0 | 50:50 | Floc | — | — | — | — | — | — | — |
| 56 | D3 | 3.0 | 50:50 | 97 | 1.34 | 39 | 100 | 100 | 154 ± 24 | 194 ± 46 | 205 (0.041) |
| 57 | D4 | 3.25 | 50:50 | 99 | 1.35 | 41 | 100 | 99 | 144 ± 15 | 174 ± 48 | 252 (0.129) |
| 58 | D5 | 3.5 | 50:50 | 98 | 1.38 | 39 | 91 | 98 | 205 ± 22 | 181 ± 45 | 198 (0.033) |
| 59 | D6 | 3.75 | 50:50 | 99 | 1.39 | 43 | 99 | 99 | 134 ± 16 | 151 ± 40 | 202 (0.069) |
| 60 | D7 | 4.0 | 50:50 | 98 | 1.35 | 43 | 80 | 96 | 141 ± 19 | 147 ± 33 | 191 (0.036) |
| 61 | D8 | 3.0 | 0:100 | Floc | — | — | — | — | — | — | — |
| 62 | D9 | 3.0 | 20:80 | Floc | — | — | — | — | — | — | — |
| 63 | D10 | 3.0 | 40:60 | Floc | — | — | — | — | — | — | — |
| 64 | D11 | 3.0 | 60:40 | 99 | 1.33 | 37 | 69 | 91 | 167 ± 19 | 163 ± 28 | 206 (0.016) |
| 65 | D12 | 3.0 | 70:30 | 99 | 1.28 | 31 | 75 | 78 | 195 ± 27 | 186 ± 34 | 246 (0.099) |
| 66 | D13 | 3.0 | 80:20 | 98 | 1.27 | 27 | 60 | 49 | 235 ± 26 | 204 ± 18 | 255 (0.036) |
| 67 | D14 | 3.0 | 100:0 | 81 | 1.25 | 27 | 50 | 50 | 305 ± 25 | 281 ± 38 | 330 (0.060 |
| 68 | D15 | none | 50:50 | 97 | 1.05 | n/a | n/a | n/a | 619 ± 22 | 602 ± 80 | 667 (0.143) |
| 69 | D16^{d} | none | 50:50 | 98 | 1.05 | n/a | n/a | n/a | — | — | 443 (0.038) |
| 70 | D17^{e} | none | 50:50 | 97 | 1.05 | n/a | n/a | n/a | — | — | 240 (0.021) |

[Note: Floc = Flocculation; Conv = conversion; Centrif = Centrifugation]
^{a}Determined gravimetrically.
^{b}Determined by helium pycnometry.
^{c}Determined by thermogravimetric analysis.
^{d}Cationic control copolymer latex prepared in the presence of 1.2 wt % (based on monomer) Triton X100 non-ionic surfactant and cationic AIBA initiator.
^{e}Anionic copolymer latex prepared in the presence of 0.3 wt % (based on monomer) SDS anionic surfactant and anionic APS initiator.

As judged by TEM, this procedure enabled purification of these samples. Particle densities of the purified samples varied from 1.34 to 1.41 g cm⁻³, but there seems to be no obvious correlation with the initial silica concentration. Silica contents seem to be slightly higher at higher initial silica concentration, but these differences probably lie within the experimental error. Compared to the PSt/SiO₂ nanocomposites, mean silica contents are significantly higher (between 39 and 43 wt %). At first sight this could be interpreted as evidence for a ‘raspberry’ nanocomposite particle morphology. TEM images also indicate partial film-formation during drying on the sample grid. DLS and DCP particle size measurements confirm that the dispersed particles have good colloidal stability and are not flocculated prior to TEM sample preparation.

### Variation of the Styrene to N-Butyl Acrylate Mass Ratio

Variation of the St/n-BuA mass ratio—which inevitably affects the overall T_{g} of the corresponding copolymer component of P(St-n-BuA)/SiO₂ nanocomposites and therefore influences their minimum film-forming temperature—was studied. The St/n-BuA mass ratio was varied systematically from an n-butyl acrylate homopolymerisation to a styrene homopolymerisation. These results are also summarised in Table 10 (entries D3 and D8 to D14).

The most well known equation for calculating the T_{g} of a statistical copolymer from the T_{g}'s of the respective homopolymers is the Fox equation. This equation assumes no interaction between the respective comonomers in the copolymer.

$$\frac{1}{{T}_{g}} = \frac{{w}_{1}}{{T}_{g 1}} + \frac{{w}_{2}}{{T}_{g 2}} + …$$

Where ωᵢ are the weight fractions of the component comonomers and T_{gi} are the corresponding homopolymer T_{g}'s. Given a Tg for PSt of 105° C. and a Tg for poly(n-BuA) of −54° C., copolymerisations at various weight ratios should allow systematic adjustment of the copolymer Tg within these boundaries.

Unfortunately, only formulations comprising at least 50 wt % styrene resulted in the formation of colloidally stable nanocomposite particles under the conditions employed in these particular examples. According to the Fox equation, this copolymer composition corresponds to a theoretical T_{g} of around 4° C., assuming that the presence of the silica does not affect the T_{g}. DSC studies on the copolymer/silica nanocomposites (entries D3 and D11-D14 in Table 10) allowed determination of their respective T_{g} values (see Table 10). These experimental onset T_{g} data are between 2.5 and 15.0° C. above the calculated theoretical values, and the discrepancies increase with increasing amounts of n-butyl acrylate comonomer. Nevertheless they do follow the expected trend. The measured T_{g} (mid-point) of 23° C. for sample D3 (50:50 P(St-n-BuA)/SiO₂ nanocomposite) is a little surprising as this nanocomposite forms homogeneous films at room temperature, and even below 20° C.

TABLE 11
Summary of glass transition temperatures (T_{g}) of P(St-n-BuA)/silica
nanocomposite particles prepared using various St/n-BuA mass ratios,
comparing theoretical and measured T_{g} values.

| Sample | St:n-BuA | Theoretical^{a} T_{g} | Onset T_{g} by | Mid-point T_{g} by |
|---|---|---|---|---|
| No. | mass ratio | (° C.) | DSC (° C.) | DSC (° C.) |
| D3 | 50:50 | 4.3 | 19.3 | 23.1 |
| D11 | 60:40 | 19.9 | 33.1 | 37.8 |
| D12 | 70:30 | 37.4 | 45.1 | 55.7 |
| D13 | 80:20 | 57.1 | 63.6 | 72.3 |
| D14 | 100:0 | 105.0 | 107.5 | 110.7 |

^{a}As calculated from equation 14, utilising homopolymer T_{g}s of 105° C. for polystyrene and −54° C. for poly(n-butyl acrylate).

The observed positive correlation between n-BuA content and difference between the measured T_{g} and the calculated T_{g} may be due to the silica sol present on the particle surface. The presence of the n-BuA component on the particle surface was confirmed by XPS and therefore a hydrogen bonding-type interaction between the silica and the n-BuA comonomer could result in reduced local chain mobility, resulting in the observed T_{g} differences.

Nanocomposite particles with reasonably narrow particle size distributions can be readily obtained, as judged by DLS and DCP measurements. TEM images showed a decreasing tendency towards film formation for higher styrene contents: individual nanocomposite particles can be observed for styrene-rich formulations. DCP data indicate that mean particle diameters increase at higher styrene contents, with the largest mean diameter being obtained for the PSt/SiO₂ homopolymer nanocomposite. The larger mean particle diameters obtained at higher styrene contents explains the systematic decrease in silica content and nanocomposite particle density, particularly if a core-shell nanocomposite morphology is assumed.

### Selective Removal of the Polymer Component

TEM images of the silica St-n-BuA nanocomposite particles discussed above suggest that these particles most likely possess a core-shell morphology. To further investigate the particle morphology, previously examined TEM samples were calcined at 550° C. This led to pyrolysis of the copolymer component, leaving the silica unaffected. TEM images of one such calcined sample are shown in FIG. 19.

The TEM images obtained after the calcination confirm that the silica forms ill-defined spherical capsules, whose size corresponds to that of the initial nanocomposite particles. This observation provides confirmation that the silica particles are located on the nanocomposite particle surface. However, since well-defined contiguous shells are not obtained, the surface concentration of the silica particles on the nanocomposite particles seems to be below full coverage.

### Particle Surface Characterisation

The surface compositions of these nanocomposite particles were characterised by aqueous electrophoresis and XPS. Zeta potential vs. pH curves for selected nanocomposite particles were also obtained.

All P(St-n-BuA)/SiO₂ nanocomposites, either prepared at 3.0 or 4.0 g silica concentration (entries D3 and D7, respectively) or variation of the St/n-BuA mass ratio (from 50:50 (D3) to 70:30 (D12)) show the same behaviour as the PS/SiO₂ homopolymer nanocomposites (D14) and the pristine silica sol (Bindzil CC 40). This suggests that the film-forming copolymer nanocomposite particles also exhibit a silica-rich particle surface, which is consistent with their suggested core-shell morphology.

With a typical sampling depth of 2-10 nm, XPS allows analysis of the chemical nature of the nanocomposite surface. As the copolymer nanocomposites film-form on drying, there is a possibility that changes in particle morphology may occur. Thus the nanocomposite particles were freeze-dried in order to preserve their original ‘wet-state’ morphology. To compare this original morphology to that of the nanocomposite films, XPS measurements were also performed on films that were either cast at room temperature (e.g. for the 50:50 P(St-n-BuA)/SiO₂ nanocomposite), or at 70° C. (styrene-rich formulations only formed films at 70° C.). XPS survey spectra recorded for each of these samples are shown in FIG. 20.

Differences between the nanocomposite particles and the corresponding films cannot be deduced from these survey spectra. In all cases the presence of the two silicon signals at 104 eV and 155 eV confirms the presence of the silica at (or near) the nanocomposite particle surface. More detailed information was obtained from the corresponding silicon, carbon and oxygen core-line spectra which were used to determine the surface atomic percentages of the freeze-dried particles and the corresponding films. To be able to compare these surface compositions to bulk compositions, bulk atomic percentages were calculated from the weight percentages obtained in TGA measurements, and a Si/C ‘bulk’ atomic ratio was determined. These data are summarised in Table 12.

TABLE 12
Summary of surface atomic percentages for carbon, oxygen and silicon
obtained from XPS core-line spectra recorded for P(St-n-BuA)/silica
nanocomposites prepared at various St/n-BuA mass ratios.
Freeze-dried particles (prior to film formation) were compared with
the corresponding films prepared either at room temperature (20° C.)
or, in the case of higher St contents, at 70° C.

| | | | | | | TGA |
|---|---|---|---|---|---|---|
| | | | | | XPS Si/C | Si/C |
| | | C 1s | O 1s | Si 2p | atomic | atomic |
| Entry No. | St:n-BuA | at % | at % | at % | ratio^{a} | ratio^{b} |
| D3 powder | 50:50 | 60.5 | 25.3 | 14.2 | 0.23 | 0.14 |
| D3 film (20° C.) | 50:50 | 57.1 | 26.7 | 16.1 | 0.28 | |
| D3 film (70° C.) | 50:50 | 54.8 | 28.9 | 16.3 | 0.30 | |
| D11 powder | 60:40 | 41.6 | 37.1 | 21.3 | 0.51 | 0.13 |
| D11 film (70° C.) | 60:40 | 68.8 | 20.5 | 10.7 | 0.16 | |
| D12 powder | 70:30 | 41.5 | 36.9 | 21.6 | 0.52 | 0.10 |
| D12 film (70° C.) | 70:30 | 53.8 | 27.4 | 18.8 | 0.35 | |
| D13 powder | 80:20 | 40.5 | 37.4 | 22.0 | 0.54 | 0.08 |
| P(St-n-BuA) latex | 50:50 | 87.9 | 11.2 | 0.9 | 0.01 | |
| control | | | | | | |

^{a}Si/C atomic ratios from the XPS surface atomic percentages determined from individual core-line spectra.
^{b}Si/C atomic ratios determined from TGA bulk atomic percentages, which were calculated from bulk weight percentages.

One difference compared to the PS/SiO₂ homopolymer nanocomposite samples is a significantly lower Si/C atomic ratio. This suggests that the silica sol is located on the particle surface, but perhaps at submonolayer coverage. This conclusion is consistent with the calcination experiments, described above. The Si/C atomic ratios are always below unity, the highest value being 0.54 obtained for sample D13 prepared at a styrene/n-butyl acrylate mass ratio of 80:20. This may be compared to PSt/SiO₂ homopolymer nanocomposites for which the Si/C ratio is either 0.83 or 1.04. Comparing the Si/C ratios of the freeze-dried 50:50 P(St-n-BuA)/SiO₂ nanocomposite particles with those of the corresponding films (both prepared at either room temperature or at 70° C.) indicates a slight increase in surface silica concentration during film formation. However, this effect is rather small and possibly within experimental error. On the other hand, surface compositions of nanocomposite films prepared at higher styrene contents indicate higher Si/C atomic ratios. Nanocomposite films formed from these samples at 70° C. reveal reduced Si/C ratios, suggesting a less silica-rich surface. In all cases the XPS ‘surface’ Si/C ratio is significantly higher than the TGA ‘bulk’ Si/C ratio, supporting the core-shell particle morphology.

### ESI/TEM Studies

For these film-forming nanocomposite particles, the core-shell morphology was also verified using ESI/TEM in combination with ultramicrotomy on sample D3 in Table 10. In the bright field image of FIG. 21, the cross-sectioned particles are easily visualised surrounded by a honeycomb structure of silica particles. The carbon and silicon elemental maps confirm that each particle consists of a copolymer core surrounded by a thin shell of silica sol. The St/n-BuA mass ratio of this sample was 50:50; nanocomposites prepared at other mass ratios exhibit similar core-shell morphologies.

### Additional Examples

From the above examples it might be concluded that nanocomposite formation is not possible where the copolymer contains less that 50% styrene. In fact, the following examples illustrate that nanocomposite particles can be made across the whole composition range, simply by increasing the silica sol concentration. Results are summarized in Table A.

Thus, one can observe that when using 4 g of Bindzil CC40 silica sol, colloidally stable nanocomposites can be obtained over the whole composition range. Run 3 in Table A shows a lower monomer conversion due to some degree of flocculation. Moreover, the particle size evolution of runs 2 and 3 does not fit with the particle size evolution of the remaining runs (in the other runs the particle size decreases when the n-BuA content increases). Nevertheless, these experiments prove that it is possible to obtain P(n-BuA) rich copolymer nanocomposites with high silica aggregation efficiencies.

TABLE A
Summary of mean particle diameters, silica contents and silica incorporation
efficiencies for various P(St-co-n-BuA)-silica nanocomposite particles prepared by
surfactant-free emulsion polymerization at 60° C. using the Bindzil CC40 silica sol
(4 g in 50 mL) and the cationic AIBA initiator (50 mg).

| | | | | | | | | Silica |
|---|---|---|---|---|---|---|---|---|
| | | | | | | Solids | Monomer | incorp'n |
| | Sample | | Monomer | Particle | | content | conversion | efficiency |
| Example | No | Monomer | mass (g) | size | PDI | (%) | (%) | (%) |
| A | 1 | n-BuA | 5.0 | 169 | 0.021 | 15.99 | 94 | 96 |
| B | 2 | n-BuA/St | 4/1 | 220 | 0.05 | 15.14 | 85 | 91 |
| C | 3 | n-BuA/St | 3/2 | 235 | 0.11 | 13.79 | 69 | 94 |
| D | 4 | n-BuA/St | 2.5/2.5 | 191 | 0.036 | | 98 | 96 |
| E | 5 | n-BuA/St | 2/3 | 210 | 0.027 | 16.06 | 94 | 73 |
| F | 6 | n-BuA/St | 1/4 | 238 | 0.029 | 15.42 | 87 | 59 |
| | 7 | St | 5.0 | 308 | 0.055 | | 83 | 50 |

### Scale Up

The PSt-silica and P(St-co-n-BuA)-silica (50/50) nanocomposites protocols were scaled up to a 1 L scale. The polymerization was executed in a 2 L flask with mechanical stirring at 250 rpm. The oxygen was removed by nitrogen bubbling in the water phase for 30 minutes prior to the reaction. In both cases colloidally stable nanocomposites were obtained. In Table B, one can observe that the results between the small-scale experiments (runs 1a and 2a) and the 1 L-scale experiments (runs 1b and 2b) are rather similar. In both cases the final particle size is a little bit larger for the large scale experiment. However, the monomer conversions and silica aggregation efficiencies are identical. Therefore, it seems clear that these experiments can be scaled up to a 1 L-scale without major problems.

TABLE B
Summary of mean particle diameters, silica contents and silica incorporation efficiencies
for the scaled-up PSt-silica and P(St-co-n-BuA)-silica nanocomposite particles prepared by
surfactant-free emulsion polymerization at 60° C. using the Bindzil CC40 silica sol and
the cationic AIBA initiator (50 mg) and the corresponding reference experiment on a small scale.

| | Silica dry | | monomer | Initiator | Particle | | Solids | Monomer | Silica incorporation |
|---|---|---|---|---|---|---|---|---|---|
| Sample No | mass (g) | Monomer | mass (g) | mass | size | PDI | content (%) | conversion (%) | efficiency (%) |
| 1a | 1.5 | St | 5 | 50 mg | 510 | 0.229 | | 83 | 90 |
| 1b | 32.4 | St | 100 | 1.00 g | 526 | 0.13 | 12.04 | 92 | 90 |
| 2a | 3 | n-BuA/St | 50/50 | 50 mg | 205 | 0.041 | | 97 | 100 |
| 2b | 64.9 | n-BuA/St | 50/50 | 1.00 g | 278 | 0.137 | 15.8 | 99 | 100 |

### (Bindzil® CC 30) and Styrene-N-Butyl Acrylate

### (Typical Synthesis Protocol)

The copolymerisations using styrene and n-butyl acrylate were conducted using the same protocol as for the Bindzil CC 30 PSt/SiO₂ nanocomposite particles. Half of the styrene was replaced by n-butyl acrylate, hence 2.5 g of styrene and 2.5 g of n-butyl acrylate were added.

Since sedimentation of the copolymer/silica particles was more difficult than for the PSt/SiO₂ particles, higher centrifugation speeds (up to 14000 rpm) had to be used. Because these soft nanocomposite particles start to form films as soon as the solvent is evaporated, powdered samples could only be obtained by freeze-drying on a Edwards Micro Modulyo apparatus after cooling with liquid nitrogen.

A summary of results obtained for P(St-n-BuA)silica nanocomposite particles is shown in Table 13.

TABLE 13

| | | | | | | DLS | | | | | | silica |
|---|---|---|---|---|---|---|---|---|---|---|---|---|
| | | | | | | particle | DCP | | | silica | silica | incorporation |
| | | | silica | solids | | diameter | particle | | silica | content | content | efficiency by |
| | | | mass | content | Conv. | (nm) | diameter | density | content by | by TGA | elemental | centrifugation |
| Example | No. | monomer(s) | (g) | (%) | (%) | (PDI) | (nm) | (g · cm⁻³) | density (%) | (%) | analysis | (%) |
| 71 | 9 | St, n-BuA | 2.00 | 12.40 | 89 | 256 (0.132) | 150 ± 27 | 1.24 | 31 | 30 | 28 | 100 |
| 72 | 10 | St, n-BuA | 2.50 | 13.13 | 88 | 188 (0.046) | — | — | — | — | — | 89 |
| 73 | 11 | St, n-BuA | 3.00 | 14.40 | 93 | 177 (0.049) | — | — | — | — | — | 84 |
| 74 | 12 | St, n-BuA | 3.50 | 15.22 | 93 | 157 (0.050) | 107 ± 27 | 1.32 | 41 | 38 | 34 | 81 |
| 75 | 13 | St, n-BuA | 4.00 | 15.71 | 90 | 154 (0.031) | — | — | — | — | — | 72 |
| 76 | 14 | St, n-BuA | 6.00 | 18.78 | 90 | 137 (0.041) | 88 ± 18 | 1.34 | 43 | 38 | 35 | 56 |

### Influence of Silica Sol Concentration

A St:n-BuA mass ratio of 50:50 was used. The initial amount of silica was varied between 2.0 g and 6.0 g in a fixed 50 ml reaction volume. A stable colloidal dispersion was obtained with 2.0 g of initial silica, but its polydispersity of 0.132 was relatively high. An increase in initial silica concentration led to a reduced mean particle diameter ranging from 190 nm to 140 nm (measured by DLS), while very low PDI values of 0.04-0.05 were achieved. As described in the previous section, the excess silica that was present in almost every reaction mixture was removed by centrifugation/redispersion. The silica incorporation efficiencies remained greater than 80% up to 4.0 g initial silica. This is a significant improvement compared to the PSt/SiO₂ formulations (i.e. styrene alone), where the silica incorporation efficiencies were typically considerably lower. Particle densities varied from 1.24 to 1.34 g·cm⁻³ and were higher in comparison to the PSt/SiO₂ nanocomposite particles, due to enhanced silica contents of 30-38% (determined by TGA). TEM images of a purified P(St-n-BuA)/SiO₂ nanocomposite sample are shown in FIG. 32.

From FIG. 3 it appears that the particles start to form a film during drying on the TEM grid. Moreover, some silica particles are observable at the surface of the partially coalesced particles. Zeta potentials of these nanocomposite particles are negative over the whole pH range, with similar electrophoretic behaviour to that of the ultrafine 12 nm silica sol itself, indicating that there is mostly silica present at the particle surface. This again is a similar observation as for the non-film-forming PSt/SiO₂ nanocomposite particles.

Comparison of the silicon: carbon (Si:C) atomic ratios of the nanocomposite particle surface calculated from XPS results (Si: C=0.18) with the value for the bulk composition calculated from TGA and elemental analysis data (Si: C=0.09) also shows that the particles have a silica-rich surface.

However, the X-ray photoelectron spectrum of a film prepared from such particles reveals a high C 1s signal, while core-line spectra exhibit a carbonyl species belonging to the n-butyl acrylate comonomer. This suggests that, despite the particles being surrounded mostly by silica, the copolymer component can also be detected at the particle surface.

Nevertheless, these results are still consistent with a ‘core-shell’ morphology, as for the non-film-forming PSt/SiO₂ particles.

It is also noted that the monomer conversions achieved in this series were slightly higher than for the non-film-forming PSt/SiO₂ nanocomposite particles, ranging from 88 to 93%.

### N-Butyl Acrylate Polymers

### (Typical Synthesis Protocol)

The appropriate amount of the aqueous silica sol (10 g equivalent to 4.0 g dry silica) and 36.12 g deionised water were added in turn to a round-bottomed flask containing a magnetic stir bar, then n-butyl acrylate monomer (5.0 g) was added. The mixture was degassed by five evacuation/nitrogen purge cycles and subsequently heated to 60° C. in an oil bath. The AIBA initiator (50.0 mg; 1.0 wt % based on monomer) was dissolved in 3.0 g of degassed water and added to give a total mass of water of 45 g. Each polymerisation was allowed to continue for 24 h. The resulting milky-white colloidal dispersions were purified by repeated centrifugation-redispersion cycles (15,000 rpm for 30 min. for P(n-BuA)-silica nanocomposites, 6,000 rpm for 30 min. for P(MMA)-silica nanocomposites and 10,000 rpm for 30 min. for P(MMA-co-n-BuA)-silica nanocomposites), with each successive supernatant being carefully decanted and replaced with de-ionised water. This was repeated until transmission electron microscopy studies confirmed that all excess silica sol had been removed by this purification protocol, which was typically the case after five cycles.

### Influence of Silica Sol Concentration

In order to optimize the silica sol incorporation efficiency, the silica sol concentration was systematically varied from 2.0 to 6.0 g (based on dry weight) in a fixed 50 ml reaction volume. TEM images of representative poly(n-BuA)-silica nanocomposites are shown in FIG. 34.

Table 14 describes the effect of changing the silica sol concentration, and also results obtained from control experiments using a non-functionalized silica sol, no silica; or replacing the cationic AIBA by the anionic APS initiator.

TABLE 14
Summary of mean particle diameters, silica contents and silica incorporation efficiencies for various poly(n-BuA)-silica
nanocomposite particles prepared by surfactant-free emulsion polymerization at 60° C.

| | | | | Silica | Monomer | Silica | Silica | Hydrodynamic | |
|---|---|---|---|---|---|---|---|---|---|
| | | Initiator | | mass | Conversion | content | incorporation | particle diameter | |
| | Entry no. | type | Silica type | (g)^{a} | (%) | (wt %)^{c} | efficiency (%) | Dᵢ(nm)^{d} | PDI |
| 77 | 1 | AIBA | Bindzil CC40 | 2.0 | No stable particles | | | | |
| 78 | 2 | AIBA | Bindzil CC40 | 3.0 | No stable particles | | | | |
| 79 | 3 | AIBA | Bindzil CC40 | 3.5 | 85 | 44 | 94 | 206 | 0.066 |
| 80 | 4 | AIBA | Bindzil CC40 | 4.0 | 94 | 45 | 96 | 169 | 0.021 |
| 81 | 5 | AIBA | Bindzil CC40 | 5.0 | 99 | 47 | 89 | 160 | 0.033 |
| 82 | 6 | AIBA | Bindzil CC40 | 6.0 | 99 | 50 | 84 | 188 | 0.073 |

| | | | | | | | | |
|---|---|---|---|---|---|---|---|---|
| 83 | 7 | AIBA | Bindzil 2040 | 4.0 | 72 | No silica | 702 | 0.149 |
| 84 | 8 | AIBA | — | — | 93 | | 750 | 0.143 |

| | | | | | |
|---|---|---|---|---|---|
| 85 | 9 | APS | Bindzil CC40 | 4.0 | No stable particle |

^{a}Mass of dry silica (supplied as a 40% aqueous dispersion).
^{b}As determined by helium pycnometry.
^{c}as determined by gravimetric analysis.
^{d}measured by dynamic light scattering using a Malvern Zetasizer Nano ZS instrument.

P(n-BuA) has a glass transition temperature of approximately −54° C. Therefore, the nanocomposites film-form on drying and lose their colloidal form. The silica is released from the particle surface during coalescence. However, one can see in FIG. 34 the presence of the poly(n-butyl acrylate) in between the silica.

When low silica sol concentrations were used (Table 14, runs 1 and 2), no stable latex was observed and the particles were flocculated. This indicated that there was insufficient silica to successfully stabilize the P(n-BuA)-silica nanocomposite particles. When higher silica sol concentrations were used (Table 14, runs 3-6), stable monodisperse nanocomposite particles with mean particle sizes of around 160-206 nm were obtained. In all cases high monomer conversions (above 95%) were obtained (the slightly lower monomer conversion for entry 3 is partly due to incipient flocculation).

An important part of this protocol is the combination of the modified (in particular glycerol-modified) silica sol with the cationic AtBA initiator. If an identical synthesis is conducted using a conventional, non-functionalized, Bindzil 2040 silica sol (Table 14, run 7), very large polydisperse particles are obtained. Moreover, the colloidal stability of this latex is poor. Similarly, changing the cationic AIBA initiator to an anionic APS initiator (Table 14, run 9) leads to coagulation during polymerization and no stable particles were obtained. These comparative examples serve to illustrate the importance of using the cationic azo initiator in combination with the glycerol modified (in particular glycerol-modified) silica sol.

### Surface Characterisation

The surface characterization of the nanocomposite particles was characterized by aqueous electrophoresis.

These zeta potential curves which were obtained reveal that there is only a very slight difference between the Bindzil CC40 silica sol itself and the nanocomposite particles: negative zeta potentials were observed over the whole investigated pH range. This suggests a silica-rich surface for the nanocomposite particles. The reference polymer latex (prepared under the same conditions but without silica) exhibited positive zeta potentials over most of the investigated pH range. This is assumed to be due to the surface amidine groups derived from the AIBA initiator. This shows that the nanocomposite surface is nearly completely covered by silica.

Poly(methyl methacrylate) P(MMA) Polymers.

Particles were prepared using a protocol similar to that described above in respect of styrene and n-butyl acrylate.

### Influence of Silica Sol Concentration

Results are summarized in Table 15

In order to optimize the silica sol incorporation efficiency, the silica sol concentration was varied from 2.0 to 5.0 g (based on dry weight) in a fixed 50 ml reaction volume. One can observe that when a low silica sol concentration is used (Table 15, run 1), no stable nanocomposite particles are obtained. When increasing the silica sol concentration stable nanocomposites can be obtained and the silica aggregation efficiency decreases (Table 15, runs 6, 7, 10, 11, 12). In all cases high monomer conversions (above 97%) and particle sizes between 330 and 500 nm are obtained. The particle size distribution becomes broader when the concentration of silica sol is increased (probably due to the excess silica). The narrowest particle size distribution is obtained for the lowest silica sol concentrations (Table 15, runs 7 and 10).

### Influence of the Initiator Mass.

In order to optimize the silica aggregation efficiencies, the initiator mass was varied between 50 and 250 mg (Table 15, runs 7-9). In all cases high monomer conversions were obtained. When a low initiator mass was used, a lower silica aggregation efficiency was observed (run 8). When a high initiator mass was used (run 9), a larger particle size and polydispersity was observed. It can therefore be suggested that the optimal initiator mass is of 150 mg (run 7). At this concentration, relatively high silica aggregation efficiencies are obtained and near-monodisperse particles are formed. TEM images of sample 7 in Table 15 are shown in FIG. 35. TEM images reveal rather monodisperse nanocomposites. However, these nanocomposites are not as spherical

TABLE 15
Summary of mean particle diameters, silica contents and silica incorporation efficiencies
for various PMMA-silica nanocomposite particles prepared by surfactant-free emulsion
polymerization at 60° C. using the Bindzil CC40 silica sol and the cationic
AIBA initiator and for controls using respectively an alternative sol and an alternative initiator.

| | | | | | | Monomer | Particle | | Silica | Silica |
|---|---|---|---|---|---|---|---|---|---|---|
| | | | Silica dry | Initiator | Initiator | conversion | diameter | | incorporation | content |
| Example | No | Silica type | mass (g)^{a} | type | mass | (%) | (nm)^{c} | PDI | efficiency (%)^{b} | (%) |
| 86 | 1 | Bindzil CC40 | 2.00 | AIBA | 50 mg | coagulation | | | | |
| 87 | 2 | Bindzil CC40 | 6.00 | AIBA | 50 mg | 99 | 289 | 0.117 | 37 | 31 |
| 88 | 3 | Bindzil CC40 | 4.00 | AIBA | 50 mg | 99 | 720 | 0.191 | 56 | 31 |
| 89 | 4 | Bindzil CC40 | 3.00 | AIBA | 50 mg | 97 | 545 | 0.094 | 66 | 28 |
| 90 | 5 | Bindzil CC40 | 3.00 | AIBA | 10 mg | 92 | 490 | 0.195 | 28 | 15 |
| 91 | 6 | Bindzil CC40 | 3.00 | AIBA | 150 mg | 99 | 422 | 0.216 | 71 | 30 |
| 92 | 7 | Bindzil CC40 | 2.50 | AIBA | 150 mg | 100 | 334 | 0.007 | 90 | 31 |
| 93 | 8 | Bindzil CC40 | 2.50 | AIBA | 50 mg | 97 | 407 | 0.047 | 68 | 26 |
| 94 | 9 | Bindzil CC40 | 2.50 | AIBA | 250 mg | 99 | 631 | 0.231 | 92 | 32 |
| 95 | 10 | Bindzil CC40 | 2.26 | AIBA | 150 mg | 97 | 445 | 0.005 | 90 | 30 |
| 96 | 11 | Bindzil CC40 | 4.00 | AIBA | 150 mg | 100 | 567 | 0.224 | 65 | 34 |
| 97 | 12 | Bindzil CC40 | 5.00 | AIBA | 150 mg | 100 | 518 | 0.17 | 55 | 35 |

| | | | | | | | | | |
|---|---|---|---|---|---|---|---|---|---|
| 98 | 13 | — | — | AIBA | 150 mg | 30 | 951 | 0.247 | Mainly coagulation |
| 99 | 14 | Bindzil CC40 | 2.50 | APS | 126 mg | 38 | 447 | 0.443 | Mainly coagulation |
| 100 | 15 | Bindzil 2040 | 2.50 | AIBA | 150 mg | | | | Mainly coagulation |

^{a}Mass of dry silica (supplied as a 40% aqueous dispersion).
^{b}As determined by gravimetric analysis.
^{c}Measured by dynamic light scattering using a Malvern Zetasizer Nano ZS instrument.

as those observed with PSt-Si nanocomposite particles.

### Control Experiment

An important part of this protocol is the combination of a modified (in particular glycerol-modified) silica sol used with the cationic AIBA initiator. If an identical synthesis is conducted using a conventional, non-functionalized Bindzil 2040 silica sol, stable nanocomposite particles cannot be obtained. Similarly, changing the cationic AIBA initiator to an anionic APS initiator leads to coagulation during polymerization; a relatively high amount of flocculation is observed and no stable particles are obtained. When using no silica, substantial flocculation is obtained and only a very limited amount of the final polymer is present as charge-stabilized cationic latex particles. Moreover, these particles are very large and very polydisperse.

### Surface Characterization

The surface of the nanocomposite particles was characterized by aqueous electrophoresis. Zeta potential measurements reveal negative zeta potentials over the whole investigated pH range for the nanocomposite as well as for the silica sol. The control P(MMA) latex (prepared without silica sol) exhibits positive zeta potentials over nearly the whole pH range. This shows that the whole nanocomposite surface is covered by silica which is in good agreement with the TEM observations.

Poly(methyl methacrylate-co-n-butyl acrylate) copolymers (P(MMA-co-n-BuA))

Polymers were prepared using the protocol as described above. Results are summarized in Table 16.

### Influence of the Silica Sol Concentration.

The silica sol concentration was varied from 2.0 to 5.0 g (based on dry weight) in a fixed 50 ml reaction volume. When a low silica sol concentration was used (Table 16, run 1 and 2), some flocculation was obtained, suggesting incomplete stabilization of the nanocomposite by the silica sol. This flocculation is responsible for a lower calculated monomer conversion (because the monomer conversion is determined without considering flocculation). On increasing the silica sol concentration stable nanocomposites can be obtained, but the silica aggregation efficiency decreases when the silica sol concentration becomes too high (Table 16, runs 3-5). In all cases high monomer conversions (above 98%) and near-monodisperse particles between 230 and 300 nm are obtained.

TABLE 16
Summary of mean particle diameters, silica contents and silica incorporation
efficiencies for various P(MMA-co-n-BuA)-silica nanocomposite particles (MMA:n-BuA
ratio 1:1) prepared by surfactant-free emulsion polymerization at 60° C. using the Bindzil
CC40 silica sol and the cationic AIBA initiator.

| | | Silica | | | | | | Silica | |
|---|---|---|---|---|---|---|---|---|---|
| | | dry | Initiator | | | Solids | Monomer | incorp'n | Silica |
| | Sample | mass | mass | Particle | | content | conversion | efficiency | content |
| Example | No | (g)^{a} | (mg) | diameter^{d} | PDI^{d} | (%) | (%)^{c} | (%)^{c} | (%) |
| 101 | 1 | 2.5 | 150 | 332 | 0.058 | 13.48 | 95 | 92 | 33 |
| 102 | 2 | 2.0 | 150 | 306 | 0.082 | 10.35 | 70 | 88 | 33 |
| 103 | 3 | 3.0 | 150 | 265 | 0.02 | 14.67 | 98 | 93 | 36 |
| 104 | 4 | 4.0 | 150 | 229 | 0.026 | 16.72 | 100 | 85 | 40 |
| 105 | 5 | 5.0 | 150 | 248 | 0.016 | 17.92 | 99 | 46 | 32 |
| 106 | 6 | 3.5 | 150 | 244 | 0.015 | 16.01 | 100 | 84 | 37 |
| 107 | 7 | 3.5 | 50 | 252 | 0.014 | 15.25 | 94 | 54 | 29 |
| 108 | 8 | 3.5 | 100 | 252 | 0.051 | 15.9 | 100 | 72 | 34 |

^{a}Mass of dry silica (supplied as a 40% aqueous dispersion).
^{c}As determined by gravimetric analysis.
^{d}Measured by dynamic light scattering using a Malvern Zetasizer Nano ZS instrument.

### Influence of the Initiator Mass.

The initiator mass was varied between 50 and 150 mg (Table 16, runs 6-8). In all cases high monomer conversions were obtained. When a low initiator mass was used, a lower silica aggregation efficiency was observed (run 7). When increasing the initiator mass from 50 to 150 mg, the silica sol incorporation efficiency increased from 54 to 84%. Therefore it is preferred to work at higher initiator concentrations. When using 150 mg initiator, relatively high silica sol aggregation efficiencies are already obtained (Table 16, run 3). Therefore it is not of particular interest to further increase the initiator concentration.

FIG. 36 shows some TEM images of these nanocomposite particles. The particle size determined from TEM images seems to correlate well with the particle size determined by the Malvern Nanosizer. Moreover, the silica seems to cover the whole nanocomposite particle surface. The sample shown in these images was prepared with high silica sol concentration (and therefore low aggregation efficiency) and was not yet purified.

### Surface Characterization.

The surface of the nanocomposite particles was characterized by aqueous electrophoresis. Zeta potential measurements indicate negative zeta potentials over the whole investigated pH range. Moreover, the nanocomposite zeta potentials are similar to the zeta potentials of the pure CC40 silica sol, confirming a silica-rich surface. Thus it can reasonably be suggested that the silica covers the whole surface of the nanocomposite particles. This is in agreement with what is observed on the TEM images.

### Poly(Vinyl Acetate) Polymers

Nanocomposite particles were prepared using the protocol outlined above. Results are shown in Table 17.

High monomer conversions and colloidally stable nanocomposites were obtained. However, the silica incorporation efficiency was rather low (39% and 58%). The particle size measurements indicated mean particle diameters around 400 nm. However, TEM images (FIG. 21) indicate particle diameters that are closer to 200 nm. This suggests some partial coagulation due to incomplete silica coverage of the particle surface. This was further evidenced when trying to purify these nanocomposites by centrifugation. Aggregation occurred and the sediments could not be re-dispersed.

TABLE 17

| | | Silica | | | | | | Silica | |
|---|---|---|---|---|---|---|---|---|---|
| | | dry | | Particle | | Solids | Monomer | incorp'n | Silica |
| | Sample | mass | Initiator | diameter | | content | conversion | efficiency | content |
| Example | No | (g) | mass | (DLS) | PDI | (%) | (%) | (%) | (%) |
| 109 | JT007 | 6 | 50 mg | 374 | 0.169 | 19.73 | 99 | 39 | 32 |
| 110 | JT016 | 4 | 50 mg | 400 | 0.157 | 16.03 | 98 | 58 | 32 |

### Comparative Examples

### Comparative Example 1

### Using an Anionic Free Radical Initiator

A 100 ml one-necked flask equipped with a magnetic flea was charged at 20° C. with 36.6 g of deionized water and 5.4 g of a 37 wt. % aqueous solution of the Bindzil® CC 40 silica sol. The pH of this aqueous reaction medium was 8.9. Then 5.0 g of styrene was added and the reaction mixture was subsequently degassed by five evacuation-nitrogen purge cycles and heated to 60° C. with stirring at 250 rpm. 50 mg of APS (ammonium persulfate) anionic free radical initiator dissolved in 5.0 g of degassed deionized water was added to the stirred reaction medium at 60° C. to start the polymerisation. The reaction mixture was stirred at 60° C. for 24 h and subsequently cooled to room temperature. Visual inspection indicated substantial coagulation and no stable particles were observed by TEM studies. Thus this comparative example demonstrates the importance of using a cationic free radical initiator to ensure efficient aggregation of the anionic silica particles.

### Comparative Example 2

### Using No Bindzil CC Silica Sol

A 100 ml one-necked flask equipped with a magnetic flea was charged at 20° C. with 40 g of deionized water and 5.0 g of styrene. The reaction mixture was subsequently degassed by five evacuation-nitrogen purge cycles and heated to 60° C. with stirring at 250 rpm. 50 mg of AIBA cationic azo initiator dissolved in 5.0 g of degassed deionized water was added to the stirred reaction medium at 60° C. to start the polymerisation. The reaction mixture was stirred at 60° C. for 24 h and subsequently cooled to room temperature. Dynamic light scattering studies indicate a mean particle diameter of 376 nm with a polydispersity of 0.126. TEM analysis of this sample confirms the presence of spherical polystyrene latex particles with a relatively broad particle size distribution. A representative TEM image is shown in FIG. 7. Thus this comparative example demonstrates that the anionic silica particles have a beneficial stabilization effect on the in situ polymerizing particles, since their use leads to the formation of smaller colloidal particles with narrower size distributions that contain a relatively high proportion of silica (see examples 1-3 above).

### Comparative Example 3

### Using a Bindzil Silica Sol that has not been Treated with Epoxysilane

A 100 ml one-necked flask equipped with a magnetic flea was charged at 20° C. with 37 g of deionized water and 5.0 g of silica sol (Bindzil® 2040 is an unfunctionalised silica sol available from EKA Chemicals AB, Sweden; it has a solids content of 40% silica by weight and a mean diameter of 20 nm according to the manufacturer). The pH of this aqueous reaction medium was 9.8. Then 5.0 g of styrene was added and the reaction mixture was subsequently degassed by five evacuation-nitrogen purge cycles and heated to 60° C. with stirring at 250 rpm. 50 mg of AIBA cationic azo initiator dissolved in 5.0 g of degassed deionized water was added to the stirred reaction medium at 60° C. to start the polymerisation. The reaction mixture was stirred at 60° C. for 24 h and subsequently cooled to room temperature. Dynamic light scattering studies indicate a mean particle diameter of 278 nm (polydispersity=0.098). However, TEM analysis confirmed that, although colloidal particles are formed, they are not evenly covered with silica particles. Rather, it seems that the silica particles merely coexist with the polystyrene particles and only become weakly associated during drying. There is no evidence for well-defined nanocomposite particles and there is a large fraction of excess (non-aggregated) silica. A representative TEM image is shown in FIG. 8. Thus this comparative example demonstrates the importance of pre-treating the surface of the anionic silica particles with an epoxysilane to ensure better adhesion between the organic polymer and inorganic silica components.

### Film Properties

### Transparency

### Bindzil CC40 P(St-n-BuA) Film Forming Nanocomposites

Macroscopic film properties were also examined. First, the optical transparency of various films was assessed. Differing volumes of a 50:50 nanocomposite aqueous dispersion were dried in PVC moulds at room temperature, leading to films of various thicknesses. After measuring the mean film thicknesses with a micrometer screw gauge, uv-visible spectroscopy was used to determine the film transmittance in each case. These spectra are shown in FIG. 23a. FIG. 23b shows the expected linear relationship between absorbance (λ=423 nm) and film thickness, thus conforming to the Beer-Lambert law.

Film thicknesses of between 76 and 284 μm were obtained and the transmission measurements confirmed that, above a wavelength of 500 nm, the transmission is higher than 80%. Below 500 nm, the films become less transparent depending on their thickness. The thickest film still shows a transmittance of more than 50% above 371 nm. As a comparison, a nanocomposite film prepared from a formulation with too low an initial silica sol concentration (D2 in Table 9), which led to its incipient flocculation, was also examined. This latter film exhibited high transparency at longer wavelengths (over 85% above 630 nm), but only 25% at 400 nm.

The excellent transparency of the nanocomposite film prepared from D3, which contained 38 wt % silica, indicates that the silica particles must be homogeneously dispersed within the film. The comparison film prepared from D2, which was appreciably flocculated prior to film formation, shows much lower transparency and appears much more opaque to the naked eye, confirming the importance of using colloidally stable dispersions when casting nanocomposite films. Digital photographs of these nanocomposite films are shown in FIG. 24.

### Bindzil CC30 P(St-n-BuA) Film Forming Nanocomposites

From the P(St-n-BuA)/SiO₂ nanocomposite particle dispersions, nanocomposite films can be cast by drying in plastic moulds at room temperature. By pouring different volumes into the moulds (1-3 ml of dispersion), films with variable thicknesses could be obtained. These films had excellent transparency (FIG. 34) and flexibility.

The light transmittance of these films was assessed by UV-visible absorption spectroscopy. The resulting spectra showed excellent transparency over the whole visible spectrum while demonstrating much lower transmittance for UV light. These properties make these nanocomposite films ideally suited for coatings and paints. Plotting the absorbance at 400 nm against the film thickness revealed a linear dependence between these two parameters, conforming perfectly to the Beer-Lambert Law

### Surface Composition—Bindzil CC30—P(St-n-BuA) Acrylate Film Forming Nanocomposites

Further studies were directed to the surface composition of these nanocomposite films and the comparison with the surface properties of the corresponding nanocomposite particles that were not film forming. The X-ray photoelectron spectrum shows a large C 1 s signal, which leads to the suggestion of copolymer chains being present at the nanocomposite particle surface, as suggested earlier for the P(St-n-BuA)/SiO₂ nanocomposite particles. More importantly, the spectrum of the nanocomposite film is very similar to the spectrum of the nanocomposite powder, indicating that the surface morphology of these particles does not change significantly during film formation.

### Effect of Controlled Addition of Silica

For a systematic study of the effect of excess silica sol on film-formation, nanocomposite sample D3 was systematically contaminated by adding various amounts of the Bindzil CC40 silica sol. The percentage of excess silica was based on the amount of silica present in the original nanocomposite film (38% by mass). This controlled addition of excess silica sol still led to fairly transparent nanocomposite films. However, these films became increasingly brittle: substantial film cracking was observed above 21% added silica (see FIG. 25). Similar results were obtained by the addition of Bindzil CC30 silica sol to a P(St-n-BuA) latex. This illustrates the importance of ensuring that the silica sol incorporation efficiency of the nanocomposite particles is as high as possible.

### Nanocomposite Control Films

To investigate the importance of nanocomposite preparation by in situ polymerisation, as opposed to ad-mixing preformed copolymer latex with silica, two control studies were performed. A preformed P(St-n-BuA) copolymer latex was mixed with various amounts of silica sol (Bindzil CC40). Two such copolymer latexes were prepared, one being cationic and the other being anionic. The cationic latex was prepared by copolymerising styrene and n-butyl acrylate using the cationic AIBA initiator in the presence of a non-ionic surfactant (Triton X100). This latex exhibited an electrostatic interaction with the anionic silica sol, similar to that proposed during the nanocomposite particle formation. Indeed upon mixing various amounts of silica sol with this latex, an immediate increase in viscosity due to particle hetero-flocculation was observed. Subsequently, the films prepared from these dispersions showed only very limited transparency, as judged by both visual inspection (FIG. 26) and transmittance measurements (FIG. 27). Even at a silica content of 10%, a significantly reduced transparency is observed for the latex/silica composite film.

The anionic control latex was prepared using anionic APS initiator and an anionic surfactant (sodium n-dodecyl sulfate). This latex was selected to ensure no electrostatic interaction with the silica sol. However, addition of various amounts of silica sol also led to nanocomposite films with reduced transparency, even when the silica content was as low as 10 wt % (see FIGS. 28 and 29). This suggests a significant advantage for in situ (co)polymerisation in the synthesis of nanocomposite particles, compared to simply pre-mixing preformed latex and silica sol.

### Burning Behaviour

In the literature it is widely recognised that polymer-inorganic oxide nanocomposites show improved fire retardancy during combustion. In general, a reduction in peak heat release rate of the nanocomposite material in comparison to the pristine polymer is observed.

To investigate whether a similar improvement could be observed for P(St-n-BuA)/SiO₂ nanocomposite films using Bindzil CC40, a simple qualitative test was performed by igniting a 50:50 nanocomposite copolymer film and monitoring the burning behaviour. This sample was compared to a film cast from a 50:50 P(St-n-BuA) copolymer latex prepared in the absence of any silica (sample D15 in Table 9). Digital images of the burning copolymer latex film at different time intervals are shown in FIG. 30 and corresponding images of the copolymer nanocomposite film are shown in FIG. 31.

The copolymer latex film easily ignites and burns completely, while molten burning plastic drips to the ground. This behaviour constitutes a major fire hazard, since it ensures rapid spreading of the flames. The combustion behaviour of the copolymer nanocomposite film is in striking contrast to the copolymer latex film. The nanocomposite film also ignites rather easily. However, its combustion is much more controlled, with no dripping molten plastic. After the copolymer component has burned completely, the silica framework remains as a monolithic black char. This burning behaviour clearly shows the superior fire-retardant property of this nanocomposite film compared to a corresponding copolymer latex film.

Similar results were obtained using a nanocomposite copolymer film using Bindzil CC30.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A process for producing composite particles comprising a polymer and a finely divided inorganic solid, the process comprising providing an aqueous dispersion of a sol of the modified finely divided solid, and mixing with at least one monomer suitable for free radical type polymerisation and a suitable free radical polymerisation initiator to initiate polymerisation of the monomer, wherein the reaction mixture is free from one or more of added surfactant, added dispersant, organic co-solvent and auxiliary co-monomer.

2. The process of claim 1, wherein the finely divided solid is modified with a modifying moiety configured for bonding interaction with the polymer.

3. The process of claim 1, wherein the modified finely divided solid is a modified silica.

4. The process of claim 3, wherein the silica sol comprises at least 20 wt % SiO₂.

5. The process of claim 4, wherein the silica sol comprises at least 30 wt % SiO₂.

6. The process of claim 3, wherein the silica has a particle size in the range of from about 5 nm to about 50 nm.

7. The process of claim 6, wherein the silica has a particle size in the range of from about 5 nm to 30 nm.

8. The process of claim 7, wherein the silica has a particle size in the range of from about 5 nm to about 20 nm.

9. The process of claim 3, wherein the modified silica is modified by silane to produce a silane-modified silica.

10. The process of claim 9, wherein the modified silica may be represented by 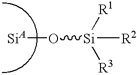
where Si^{A} is a silicon atom of a silica particle, [symbol] represents a link between O and Si and may be a bonding interaction or an intermediate linking atom or linking group, R¹ and R³ independently represent H, C₁ to C₆ alkyl or OR⁹ where R⁹ represents C₁ to C₆ alkyl, and R² represents a C₂ to C₁₂ straight chain or branched alkyl group including at least one terminal oxygen containing group and the alkyl chain of R² may optionally be interrupted by one or more moieties selected from O, S, NH.

11. The process of claim 10, wherein the modified silica may be represented by 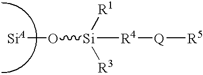
where R⁴ represents C₁ to C₆ alkyl, Q represents a moiety selected from O, S, NH, and R⁵ represents a straight chain or branched alkyl group including at least one terminal oxygen containing group.

12. The process of claim 11, wherein Q represents O.

13. The process of claim 11 wherein R⁵ is selected from 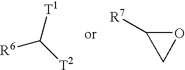
where R⁶ and R⁷ represent CH₂ or CH₂CH₂, T¹ and T² independently represent H, OH or R⁸OH where R⁸ is CH₂ or CH₂CH₂, provided that T¹ and T² are not both H.

14. The process of claim 13, wherein T¹ is OH and T² is CH₂OH.

15. The process of claim 10, wherein R¹ and R³ are selected from CH₃, CH₂CH₃, OCH₃ and OCH₂CH₃.

16. The process of claim 9, wherein the weight ratio of silane to silica is from about 0.05 to about 1.

17. The process of claim 3, wherein the silica sol has a pH in the range of from about 5 to about 9.

18. The process of claim 3, wherein the modified silica comprises a modifying moiety that comprises a terminal hydroxy group.

19. The process of claim 1, wherein the monomer comprises at least one ethylenically unsaturated group.

20. The process of claim 19, wherein the monomer is selected from the group consisting of ethylene, vinyl aromatic monomers, esters of vinyl alcohol and C₁-C₁₈ monocarboxylic acids, esters of C₃-C₆ α,β-monoethylenically unsaturated mono- and di-carboxylic-acids, nitriles of α,β-monoethylenically unsaturated carboxylic acids, C₄-C₈ conjugated dienes, α,β-monoethylenically unsaturated mono- and dicarboxylic acids and their amides, vinylsulfonic acid, 2-acrylamido-2-methylpropanesulfonic acid, styrene-sulfonic acid and the water-soluble salts thereof, and N-vinylpyrrolidone.

21. The process of claim 19, wherein the monomer is selected from the group comprising esters of C₃-C₆ α,β-monoethylenically unsaturated mono- and di-carboxylic-acids with C₁-C₈ alkanols.

22. The process of claim 19, wherein the monomer is a styrene.

23. The process of claim 19, wherein the monomer is methyl methacrylate.

24. The process of claim 19, wherein the monomers comprise a styrene and an ester of a C₃-C₆ α,β-monoethylenically unsaturated mono- and di-carboxylic acids selected from, such as acrylic acid, methacrylic acid, maleic acid, fumaric acid and itaconic acid, with C₁-C₁₂ alkanols selected from methyl, ethyl, n-butyl, isobutyl and 2-ethylhexyl acrylate and methacrylate, dimethyl maleate and din-butyl maleate.

25. The process of claim 24, wherein the monomers comprise a styrene and a C₁ to C₁₂ alkyl acrylate.

26. The process of claim 25, wherein the monomers comprise styrene and n-butyl acrylate.

27. The process of claim 19, wherein the monomers comprise methyl methacrylate and n-butyl acrylate.

28-60. (canceled)

61. The process of claim 20, wherein
i) the vinyl aromatic monomers are selected from styrene, α-methylstyrene, o-chlorostyrene or vinyltoluenes;
ii) the esters of vinyl alcohol and C₁-C₁₈ monocarboxylic acids are selected from vinyl acetate, vinyl propionate, vinyl n-butyrate (ethenyl butanoate), vinyl laurate and vinyl stearate;
iii) the esters of C₃-C₆ α,β-monoethylenically unsaturated mono- and di-carboxylic-acids are selected from acrylic acid, methacrylic acid, maleic acid, fumaric acid and itaconic acid, with C₁-C₁₂ alkanols selected from methyl, ethyl, n-butyl, isobutyl and 2-ethylhexyl acrylate and methacrylate, dimethyl maleate and di-n-butyl maleate;
iv) the nitrile of α,β-monoethylenically unsaturated carboxylic acids is acrylonitrile;
v) the C₄-C₈ conjugated dienes are selected from 1,3-butadiene and isoprene; or
vi) the α,β-monoethylenically unsaturated mono- and dicarboxylic acids and their amides is selected from acrylic acid, methacrylic acid, maleic acid, fumaric acid, itaconic acid, acrylamide and methacrylamide.

62. The process of claim 21, wherein the monomer comprises esters of C₃-C₆ α,β-monoethylenically unsaturated mono- and di-carboxylic-acids with C₁-C₄ alkanols.

63. The process of claim 1, wherein the initiator is a cationic azo initiator.

64. The process of claim 1, wherein the composite particles have a zeta potential which is substantially the same as that of the initial finely divided solid.

65. The process of claim 1, wherein the composite particles have a diameter in the range of from about 50 nm to about 1000 nm.

66. The process of claim 65, wherein the composite particles have a diameter in the range of from about 100 nm to about 600 nm.

67. The process of claim 66, wherein the composite particles have a diameter in the range of from about 150 nm to about 450 nm.

68. The process of claim 1, wherein a dispersion of the composite particles has a finely divided particle aggregation efficiency in the range of from about 70% to about 100%.

69. The process of claim 68, wherein a dispersion of the composite particles has a finely divided particle (preferably silica) aggregation efficiency in the range of from about 90% to about 100%.

70. The process of claim 1, wherein the composite particles have a silica content in the range of from about 10 wt % to about 80 wt %.

71. The process of claim 70, wherein the composite particles have a silica content in the range of from about 15 wt % to about 50 wt %.

72. The process of claim 71, wherein the composite particles have a silica content in the range of from about 15 wt % to about 40 wt %.

73. An aqueous composition comprising composite particles comprising a polymer and a finely divided inorganic solid when obtained or when obtainable by a process as claimed in claim 1.

74. An aqueous composition comprising composite particles, said composite particles comprising a polymer formed by polymerisation of a styrene and an ester of a ethylenically unsaturated mono- and di-carboxylic acids, and a modified finely divided solid.

75. The aqueous composition of claim 74, wherein said ester of a ethylenically unsaturated mono- and di-carboxylic acids is selected from acrylic acid, methacrylic acid, maleic acid, fumaric acid and itaconic acid with C₁-C₁₂ alkanols selected from methyl, ethyl, n-butyl, isobutyl and 2-ethylhexyl acrylate and methacrylate, dimethyl maleate and di-n-butyl maleate.

76. The composition of claim 74, wherein the finely divided solid is modified with a modifying moiety configured for bonding interaction with the polymer.

77. The composition of claim 74, wherein the modified finely divided solid is a modified silica.

78. The composition of claim 77, wherein the modified silica is a silica sol comprising at least 20 wt % SiO₂.

79. The composition of claim 78, wherein the silica sol comprises at least 30 wt % SiO₂.

80. The composition of claim 77, wherein the silica has a particle size in the range of from about 5 nm to about 50 nm.

81. The composition of claim 80, wherein the silica has a particle size in the range of from about 5 nm to about 30 nm.

82. The composition of claim 81, wherein the silica has a particle size in the range of from about 5 nm to about 20 nm.

83. The composition of claim 76, wherein the modifying moiety is a silane that produces a silane-modified silica.

84. The composition of claim 83, wherein the modified silica may be represented by 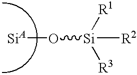
where Si^{A} is a silicon atom of a silica particle, [symbol] represents a link between O and Si and may be a bonding interaction or an intermediate linking atom or linking group, R¹ and R³ independently represent H, C₁ to C₆ alkyl or OR⁹ where R⁹ represents C₁ to C₆ alkyl and R² represents a C₂ to C₁₂ straight chain or branched alkyl group including at least one terminal oxygen containing group and the alkyl chain of R² may optionally be interrupted by one or more moieties selected from O, S, NH.

85. The composition of claim 84, wherein the modified silica may be represented by 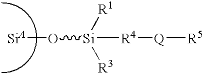
where R⁴ represents C₁ to C₆ alkyl, Q represents a moiety selected from O, S, NH, and R⁵ represents a straight chain or branched alkyl group including at least one terminal oxygen containing group.

86. The composition of claim 85, wherein Q represents O.

87. The composition of claim 85, wherein R⁵ is selected from 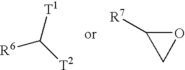
where R⁶ and R⁷ represent CH₂ or CH₂CH₂, T¹ and T² independently represent H, OH or R⁸OH where R⁸ is CH₂ or CH₂CH₂, provided that T¹ and T² are not both H.

88. The composition of claim 87, wherein T¹ is OH and T² is CH₂OH.

89. The composition of claim 84, wherein R¹ and R³ are selected from CH₃, CH₂CH₃, OCH₃ and OCH₂CH₃.

90. The composition of claim 83, wherein the weight ratio of silane to silica is from about 0.05 to about 1.

91. The composition of claim 78, wherein the silica sol has a pH in the range of from about 5 to about 9.

92. The composition of claim 76, the modifying moiety comprises a terminal hydroxy group.

93. The composition of claim 73, wherein said composition is film-forming.

94. The composition of claim 73, wherein the composite particles have a zeta potential which is substantially the same as that of the initial finely divided solid.

95. The composition of claim 73, wherein the composite particles have a diameter in the range of from about 50 nm to about 1000 nm.

96. The composition of claim 95, wherein the composite particles have a diameter in the range of from about 100 nm to about 600 nm.

97. The composition of claim 96, wherein the composite particles have a diameter in the range of from about 150 nm to about 450 nm.

98. The composition of claim 73, wherein a dispersion of the composite particles has a finely divided particle aggregation efficiency in the range of from about 70% to about 100%.

99. The composition of claim 98, wherein the dispersion of the composite particles has a finely divided particle aggregation efficiency in the range of from about 90% to about 100%.

100. The composition of claim 99, wherein said finely divided particles are silica.

101. The composition of claim 73, wherein the composite particles have a silica content in the range of from about 10 wt % to about 80 wt %.

102. The composition of claim 101, wherein the composite particles have a silica content in the range of from about 15 wt % to 50 wt %.

103. The composition of claim 102, wherein the composite particles have a silica content in the range of from about 15 wt % to 40 wt %.

104. A filmic substrate prepared from the composition of claim 73.

105. A paint or coating composition comprising the composite particles of claim 73.

106. The composition of claim 74, wherein said composition is film-forming.

107. The composition of claim 74, wherein the composite particles have a zeta potential which is substantially the same as that of the initial finely divided solid.

108. The composition of claim 74, wherein the composite particles have a diameter in the range of from about 50 nm to about 1000 nm.

109. The composition of claim 108, wherein the composite particles have a diameter in the range of from about 100 nm to about 600 nm.

110. The composition of claim 109, wherein the composite particles have a diameter in the range of from about 150 nm to about 450 nm.

111. The composition of claim 74, wherein a dispersion of the composite particles has a finely divided particle aggregation efficiency in the range of from about 70% to about 100%.

112. The composition of claim 111, wherein the dispersion of the composite particles has a finely divided particle aggregation efficiency in the range of from about 90% to about 100%.

113. The composition of claim 112, wherein said finely divided particles are silica.

114. The composition of claim 74, wherein the composite particles have a silica content in the range of from about 10 wt % to about 80 wt %.

115. The composition of claim 114, wherein the composite particles have a silica content in the range of from about 15 wt % to 50 wt %.

116. The composition of claim 115, wherein the composite particles have a silica content in the range of from about 15 wt % to 40 wt %.

117. The composition of claim 74, wherein at least some of said composite particles have a morphology comprising a polymer core and a shell of the finely divided solid surrounding the core.

118. The composition of claim 117, wherein the core comprises finely divided solid particles dispersed therein.

119. The composition of claim 74, wherein at least some of said composite particles have a morphology in which the finely divided solid is dispersed throughout the polymer particle with no contiguous shell layer

120. A filmic substrate prepared from the composition of claim 74.

121. A paint or coating composition comprising the composite particles of claim 74.
